(19) United States
(12) Patent Application Publication
(10) Pub. No.: US 2006/0204730 A1
(43) Pub. Date: Sep. 14, 2006

(54) Light-shielding image-carrying substrate, method of forming light-shielding image, transfer material, color filter, and display device

(75) Inventors: Hideyuki Nakamura, Shizuoka-ken (JP); Takeshi Ando, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/356,062

(22) Filed: Feb. 17, 2006

(30) Foreign Application Priority Data
Mar. 9, 2005 (JP) 2005-066154

(51) Int. Cl. B32B 27/18

(52) U.S. Cl. 428/195.1; 428/328

(57) ABSTRACT

The present invention provides a light-shielding image-carrying substrate including a substrate and a light-shielding image formed on at least part of at least one face of the substrate, wherein the light-shielding image includes at least two layers, and at least one of the at least two layers is a light-absorbing layer containing shape-anisotropic fine metal particles, and at least one layer of the at least two layers is a reflected light-absorbing layer.

### CROSS-REFERENCE TO RELATED APPLICATION

This application claims priority under 35 USC 119 from Japanese Patent Application No. 2005-66154, the disclosure of which is incorporated by reference herein.

### BACKGROUND OF THE INVENTION

1. Field of the Invention

The present invention relates to a light-shielding image-carrying substrate, a method of forming a light-shielding image, a transfer material, a color filter, and a display device.

2. Description of the Related Art

The “light-shielding images” according to the invention include so-called black matrixes (hereinafter, referred to as “BM”) such as the black frames formed at the periphery of display devices, including liquid crystal display devices, plasma display devices, EL display devices, and CRT display devices, the grid- or stripe-shaped black areas at the interfaces of red, blue, and green pixels, and dot- or line-shaped black patterns for protecting TFTs from light; and various other light-shielding images. The light-shielding image is formed with a colored composition for black material. Such colored compositions for black material are widely used as, for example, printing ink, inkjet ink, etching resist, solder resist, partition walls of plasma display panels (PDP), dielectric patterns, electrode (conductive circuit) patterns, wiring patterns of electronic parts, conductive paste, conductive film, and light-shielding images such as a black matrix.

The BM, which is used for improvement in display contrast and, when it is used in a liquid crystal display device in the active matrix driving mode using a thin film transistor (TFT), prevention of deterioration in image quality due to electrical leakage by light, should have high light-shielding efficiency (optical density OD of 3 or more).

Liquid crystal display devices have been applied to and used as TV sets recently. Since a color filter having low transmittance and high color purity is used in the TV set, obtaining high brightness requires a backlight to have high brightness. For this reason, high light-shielding efficiency is demanded for the BMs, for prevention of decrease in contrast and light transmission through peripheral frame regions.

In addition, TV sets are normally placed in a room where sunlight enters for an extended period of time, and thus, there is a concern about the deterioration of TFTs by sunlight. High light-shielding efficiency is also required for BMs for the following reasons: (1) high OD of the BMs providing high image definition, and, in other words, improving contrast; and (2) suppressing whitening of liquid crystal caused by external light.

To form a BM having, as the light-shielding layer, a film of metal such as chromium, for example, a BM-forming method of forming a thin metal film by vapor deposition or sputtering, coating a photoresist on the thin metal film, exposing the photoresist layer to light through a photomask having a pattern for BM, developing the layer, etching the exposed thin metal film, and finally removing the resist layer on the thin metal film is disclosed (e.g., “Color TFT Liquid Crystal Display” pp. 218 to 220 (Apr. 10, 1997), published by Kyoritsu Shuppan Co., Ltd.).

Although the thickness of the thin metal film used in this method is small, the film has high light-shielding efficiency. However, the method demands a vacuum film-making process such as vapor deposition or sputtering and an etching process, resulting in increased cost and considerable environmental burden. Moreover, its display contrast is low under a strong external light, because the metal film is highly reflective. To solve the latter problem, a low-reflection chromium film (e.g., a film consisting of a metal chromium layer and a chromium oxide layer) may be used as the thin metal film, but this inevitably results in further increase in cost.

Another BM-forming method in which a photosensitive resin composition containing a light-shielding pigment such as carbon black is used is also known. For example, a BM-forming method in the self-alignment mode of forming R, G and B pixels on a transparent substrate, applying a carbon black-containing photosensitive resin composition to the pixel-formed surface of the transparent substrate, and exposing the entire surface of the pixel-formed surface to light from the other surface of the transparent substrate is known (e.g., Japanese Patent Application Laid-Open (JP-A) No. 62-9301).

This method is advantageous in that the production cost is lower than that of the method involving etching of the metal film. However, the BM must be thick to obtain sufficient light-shielding efficiency. As a result, big level difference occurs in portions where the BM and the R, G, and B pixels overlap each other. Accordingly, the color filter has poor smoothness, and cell-gap irregularity of the liquid crystal display device occurs, consequently leading to display defects such as unevenness in color.

Alternatively, a method of preparing a BM containing light-shielding metal particles having a particle diameter of 0.01 to 0.05 μm uniformly dispersed therein has been proposed (e.g., Japanese Patent No. 3318353). In this method, a photoresist layer containing a hydrophilic resin is formed on a transparent substrate and exposed to light via a photomask having a BM pattern. The exposed layer is developed to form a relief on the transparent substrate. The transparent substrate is brought into contact with an aqueous solution of a metal compound, which functions as a catalyst for electroless plating, to introduce the metal compound into the relief. The transparent substrate is dried and heated. Thereafter, the relief on the transparent substrate is brought into contact with an electroless plating solution. Examples of the metal particles described in the patent include particles of nickel, cobalt, iron, copper, and chromium, and the only type of the metal particles used in the Examples are nickel particles.

However, the method involves various tedious steps using water, including relief-forming which includes exposure and developing steps, addition of an electroless plating catalyst, heat treatment, and electroless plating. Thus, BM production at low cost cannot be greatly expected.

Alternatively, JP-A No. 2001-13678 discloses use of a magnetic filler in a colored composition for forming a black pattern, but the BMs thus obtained have a thick film of 10 μm or more in thickness and are low in density per unit film thickness, and thus a thin light-shielding image that is high in light-shielding efficiency cannot be produced at low cost.

Due to the above-mentioned problems, there exists a need for a thin-film BM that is high in light-shielding efficiency.

In addition, the BM should have a low reflectance, in view of the following problems.

High light reflectance at a viewer side of the BM (visible light reflectance at the transparent substrate side of the color filter) causes deterioration in display contrast under a strong external light, and high light reflectance in a liquid crystal cell leads to generation of photoleak current by reflection of backlight and consequently to malfunction of a thin film transistor (JP-A No. 8-146410, paragraph No. [0005]).

Thus, the BM desirably has a low reflectance to light from the inside and that from the outside of a liquid crystal display device in order to obtain a liquid crystal display device having high display quality.

As described above, although there is a need for a thin-film BM that is low in environmental burden, high in light-shielding efficiency and low in reflectance, there is still no BM satisfying the need.

As described above, there exists a need for a thin-film liquid crystal display device, replacing conventional black matrixes of, for example, chromium that is low in environmental burden, high in light-shielding efficiency, and high in display contrast, and that controls photoleak current which can lead to malfunction of the liquid crystal display device.

Thus, there is a need for a thin light-shielding image-carrying substrate that is high in light-shielding efficiency, and, particularly when seen from the viewer side, low in reflectance, and that suppresses light reflection in a liquid crystal cell and prevents malfunction of a thin film transistor due to photoleak current when applied, for example, to a liquid crystal display device.

There is also a demand for a thin-layered transfer material for obtaining a light-shielding image that is high in light-shielding efficiency and, when seen from the viewer side, low in reflectance.

Further, there is a need for a color filter that is high in display contrast and superior in smoothness, and a display device using the same.

### SUMMARY OF THE INVENTION

A first aspect of the invention provides a light-shielding image-carrying substrate including a substrate and a light-shielding image formed on at least part of at least one face of the substrate, wherein the light-shielding image includes at least two layers, and at least one of the at least two layers is a light-absorbing layer containing shape-anisotropic fine metal particles, and at least one of the at least two layers is a reflected light-absorbing layer.

A second aspect of the invention provides a transfer material including a temporary support and at least two layers thereon, wherein at least one of the at least two layers is a reflected light-absorbing layer and at least one layer of the at least two layers is a light-absorbing layer containing shape-anisotropic fine metal particles.

A third aspect of the invention provides a method of forming a light-shielding image involving: providing the aforementioned transfer material and transferring the at least two layers on the temporary support onto a substrate; patternwise exposing the at least two layers; and developing the at least two layers patternwise exposed to remove an unexposed area.

A fourth aspect of the invention provides a color filter prepared by using the light-shielding image-carrying substrate.

A fifth aspect of the invention provides a color filter prepared by using the transfer material.

A fifth aspect of the invention provides a display device having the light-shielding image-carrying substrate and the color filter.

The invention provides a thin-layered light-shielding image-carrying substrate that is high in light-shielding efficiency and, when seen from the viewer side, low in reflectance.

The invention also provides a transfer material for preparing a thin-layered light-shielding image that is high in light-shielding efficiency and, especially when seen form the viewer side, low in reflectance, a filter superior in display contrast and smoothness, and a display device using the same.

When operated in the active matrix driving mode, the liquid crystal display device of the invention allows reductions in light reflectance on a liquid crystal cell side, in the amount of stray light in the liquid crystal, and in the amount of photoleak current which leads to malfunction of TFTs, and thus is effective in reducing power consumption and improving the contrast ratio of LCDs. The invention, which uses a resin relief, allows easy formation of a black matrix pattern, and, when, for example, a photosensitive resin or an electron beam resist is used, can improve dimensional accuracy.

### DETAILED DESCRIPTION OF THE INVENTION

Light-Shielding Image-Carrying Substrate

The light-shielding image-carrying substrate of the invention has a substrate and a light-shielding image formed in at least part on at least one face of the substrate. The light-shielding image has at least two layers. At least one of the at least two layers is a light-absorbing layer containing shape-anisotropic fine metal particles, and at least one of the at least two layers is a reflected light-absorbing layer.

As described above, the light-shielding image-carrying substrate of the invention includes a light-shielding image having a laminated structure of at least two layers including a reflected light-absorbing layer and a light-absorbing layer containing shape-anisotropic fine metal particles. Therefore, the light-shielding image is a thin layer and has high light-shielding efficiency, and, particularly when seen from the viewer side, has low reflectance.

The light-shielding image-carrying substrate of the invention may be used without restriction in such applications as television, personal computer, liquid crystal projector, video game computer, portable terminals (e.g., cellular phone), digital camera, and car navigation system.

Hereinafter, the light-shielding image-carrying substrate of the invention will be described.

<Light-Shielding Image>

The light-shielding image of the invention has at least two layers, including a light-absorbing layer containing shape-anisotropic fine metal particles and a reflected light-absorbing layer. The light-shielding image may have other layer. At least one of the at least two layers is preferably a resin layer.

As described above, the light-shielding image may be used as the BMs such as the black frame at the periphery of display devices including liquid crystal display devices, plasma display devices, EL display devices, and CRT devices, the grid- or stripe-shaped black areas at the interfaces of red, blue, and green pixels, and dot- or line-shaped black patterns for protecting TFTs from light. Among these, the light-shielding image is particularly preferably used in liquid crystal display devices.

The reflectance of the light-shielding image, measured on the substrate side of thereof, at a wavelength of 555 nm is preferably 0.01 to 2%, more preferably, 0.1 to 1.5%, and most preferably 0.7 to 1.0%. The reflectance of the light-shielding image is preferably low. When the reflectance of the light-shielding image is within the above range, such a light-shielding image can be easily formed. Moreover, when the light-shielding image is used in a liquid crystal display device, the device has sharp contrast and whitening of the liquid crystal caused by external light is suppressed.

The total thickness of the light-shielding image is preferably in the range of 0.2 to 0.8 μm, more preferably 0.3 to 0.6 μm, and most preferably 0.4 to 0.5 μm. When the thickness is in the above range, the light-shielding image is superior in light-shielding property, and the surfaces of red, blue, and green pixels which are formed after formation of the light-shielding image are smooth, and frequency of unevenness in color is reduced. Furthermore, considerable planar defects due to coarse particles can be prevented.

The optical transmission density of the light-shielding image at a wavelength of 555 nm is preferably 4 to 20, more preferably 5 to 15, and most preferably 8 to 12 per 1 μm of thickness. When the optical transmission density per μm is within the above range, the light-shielding image is high in contrast, and superior display quality can be obtained, and such problems as light transmission in the frame region caused by backlight can be prevented. The optical transmission density per μm is preferably as high as possible for improvement in contrast. However, it might be difficult to produce a light-shielding image having an optical transmission density of more than 20. Therefore, as described above, the optical transmission density is preferably within the above range.

The light-shielding image is required to have properties, such as heat resistance, light resistance, chemical resistance, surface smoothness, and hardness, similar to those of color filters. The required properties are described in, for example, “Production Techniques and Chemicals of Color Filters (supervised by Junji Watanabe, and published by CMC Publishing in 1998)”, P. 189, and “Next-Generation Liquid Crystal Display Technology (written by Tatsuo Uchida, and published by Kogyo Chosakai Publishing Inc. in 1994)”, p. 117. These required properties can be controlled by adjusting a ratio of the amount of a pigment to that of a binder, the kind of binder, and conditions of exposure and heat treatment, as in conventional BMs.

The light-shielding image is preferably formed on the substrate of the light-shielding image-carrying substrate of the invention according to a method of forming a light-shielding image described later.

Light-Absorbing Layer

The light-absorbing layer in the invention has high light-absorbing efficiency. The reason for this is thought to be that the layer contains shape-anisotropic fine metal particles having high light-absorbing ability. The high light-absorbing efficiency enables reducing the thickness of the light-shielding image necessary to obtain a desired light-shielding effect. Moreover, its shape-anisotropic effect and wide particle size distribution seem to be effective in giving high blackness.

The light-absorbing layer in the invention contains at least one kind of shape-anisotropic fine metal particles, and may further contain pigment fine particles, a binder polymer, a photopolymerizable monomer, a photopolymerization initiator, and a solvent. The shape anisotropy means that at least one of the length, width and height of a particle is different from the other(s). The shape of the particle differs according to the direction along which a viewer sees the particle.

A combination of the light-absorbing layer containing the shape-anisotropic fine metal particles and having high shielding efficiency and blackness, and a reflected light-absorbing layer can be used as, for example, the material for a photomask, the material for a printing proof, an etching resist material, partition walls in plasma display panels (PDP), dielectric patterns, electrode (conductive circuit) patterns, wiring patterns of electronic parts, conductive films, and light-shielding images such as black matrix. Preferably, it is used in forming a light-shielding image in, for example, gaps between pixels, the peripheral area around a colored pattern composed of the pixels and the surface of TFT which surface is on the external light side, for improvement in the display characteristics of the color filter used in display devices such as color liquid crystal display devices. In particular, it is preferably used as BMs such as the black frame formed at the periphery of display devices such as liquid crystal display devices, plasma display devices, EL display devices, and CRT display devices, the grid- or stripe-shaped black area at the interfaces of red, blue, and green pixels, and the dot- or line-shaped black pattern for protection of TFT from light.

The light-absorbing layer in the invention has not only high efficiency of absorbing light entering the layer from the viewer side but also a low reflectance. Therefore, when the layer is used in a liquid crystal device, the amount of optical leak current due to return light of backlight is small and malfunction of the TFT is prevented.

<Shape-Anisotropic Fine Metal Particles>

The light-absorbing layer in the invention contains shape-anisotropic fine metal particles. The shape-anisotropic fine metal particles in the invention have a non-spherical shape having shape anisotropy, and otherwise they are not particularly limited. The shape of these particles is preferably irregular, rod-like (e.g., needle-like, cylindrical, prism-like such as rectangular prism-like, or rugby ball-like), tabular (e.g., scale-like, elliptical, or plate-like), fiber-like, rounded protrusions-having sphere-like, or coil-like. The particles are more preferably rod-shaped, irregular, or plate-shaped.

—Fine Metal Particles—

The “metal” in the invention is the metal described in “Dictionary of Chemistry 2”, reduced-size edition, 38th print, published by Kyoritsu Shuppan Co., Ltd. on Oct. 1, 2003, and is generally a substance that has so-called metallic luster, high electric and thermal conductivities, high strength, ductility and malleability, and, when bent, hardly fractures, and is solid at room temperature, and is relatively hard to melt.

The shape-anisotropic fine metal particles in the invention can be any metal particles having the shape anisotropy described above. The fine metal particles in the invention preferably contain, as the primary component, a metal selected from the group consisting of the metals in the fourth, fifth, and sixth periods in the periodic table of elements (IUPAC 1991), and more preferably contains, as the primary component, a metal selected from the group consisting of the metals in Groups 2, 4, 6, 8, 9, 10, 11, 12, 13, and 14. Among these metals, the shape-anisotropic fine metal particles in the invention still more preferably contain a metal in the third, fourth, fifth, or sixth period and in Group 2, 4, 6, 10, 11, 12, 13, or 14.

The fine metal particles may contain two or more metals, and these metals can be an alloy.

Typical examples of the metal of the dispersed fine metal particles include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and alloys thereof. The metal is preferably at least one selected from copper, silver, gold, platinum, palladium, nickel, tin, cobalt, calcium, rhodium, iridium and alloys thereof, more preferably at least one selected from copper, silver, gold, platinum, tin, and alloys thereof, still more preferably gold, silver, copper, and/or tin and most preferably silver. Silver is preferably rod-shaped. In addition, silver is more preferably colloidal silver.

—Metal Compound Fine Particles, and Composite Fine Particles—

Alternatively, the shape-anisotropic fine metal particles in the invention may be metal compound fine particles, or composite fine particles of a metal compound and a metal.

The “metal compound” in the invention is a compound of the metal described above and an element other than metal. Examples of the compound of such a metal and other element include metal oxides, metal sulfides, metal sulfates, and metal carbonates. Among them, the metal compound is preferably a metal sulfide. This is because a metal sulfide has preferable color tone, and it is easy to produce metal sulfide fine particles. Examples of the metal compound include copper oxide (II), iron sulfide, silver sulfide, copper sulfide (II), and titanium black. Silver sulfide is particularly preferable form the viewpoints of color tone, easiness of preparing fine particles thereof, and stability.

The composite fine particles of a metal compound and a metal in the invention are particles in which the metal and the metal compound are bound to each other. The configuration of the composite particles is not particularly limited. For example, the particles may have inner and surface portions having different compositions, or may be fused particles of two kinds of particles. The composite fine particles may include one or more metal compound and one or more metal. Typical examples of the composite fine particles of a metal compound and a metal include composite fine particles of silver and silver sulfide, and composite fine particles of silver and copper oxide (II).

—Core-Shell-Type Composite Particles—

Further, the shape-anisotropic metal particles in the invention may be core-shell-type composite particles. The core-shell-type composite particles are particles in which the surface of a core material particle is coated with a shell material. Examples of the shell material of the core-shell-type composite particles include semiconductors such as Si, Ge, AlSb, InP, Ga, As, GaP, ZnS, ZnSe, ZnTe, CdS, CdSe, CdTe, PbS, PbSe, PbTe, Se, Te, CuCl, CuBr, CuI, TlCl, TlBr, TlI, solid solutions thereof, and solid solutions containing at least one of these materials in an amount of 90 mol % or more; and metals such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and alloys thereof. The core-shell-type composite particles may include one or more of these materials

The shell material is preferably copper, silver, gold, palladium, nickel, tin, bismuth, antimony, lead, and/or at least one alloy thereof.

The shell material is favorably used as an agent for controlling refractive index in order to reduce reflectance.

For example, at least one metal selected from copper, silver, gold, palladium, and alloys thereof can be used as the core material of the core-shell-type composite particles.

A method for producing the core-shell-type composite particles is not particularly limited, and typical examples thereof include the following methods (1) and (2).

(1) A method of preparing fine metal particles by a known method and oxidizing or sulfurizing the surfaces of the fine metal particles to form a shell of a metal compound thereon. For example, fine metal particles are dispersed in a dispersion medium such as water and a sulfide such as sodium sulfide or ammonium sulfide is added to the particles. The particle surfaces are then sulfurized to form core-shell-type composite particles.

In this case, the fine metal particles can be prepared by any known method such as a gas- or liquid-phase method. Methods of producing fine metal particles are described in, for example, “Latest Movement II in Technology and Application of Ultra-Fine Particles (published by SB Techno-Research Co., Ltd. in 2002)”.

(2) A method of preparing fine metal particles and successively forming a shell of a metal compound on the surfaces of the fine metal particles. For example, a reducing agent is added to a metal salt solution to reduce a part of the metal ions contained in the solution and to form fine metal particles, and a sulfide is added to the reaction system to form a metal sulfide coating on the surfaces of the fine metal particles.

—Preparation of Shape-Anisotropic Metal Particles—

The shape-anisotropic metal particles may be a commercially available product or may be prepared by, for example, chemical reduction of metal ions, electroless plating, or metal vapor deposition.

For example, Adv. Mater. 2002, 14, 80-82 discloses that rod- or wire-shaped silver fine particles can be produced by adding a silver salt to spherical silver fine particles serving as seed particles, and reducing the silver salt with such a reducing agent having a relatively low reducing property as ascorbic acid in the presence of a surfactant such as cetyltrimethylammonium bromide (CTAB). Similar methods are described in Mater. Chem. Phys. 2004, 84, 197-204, and Adv. Funct. Mater. 2004, 14, 183-189.

A method for forming shape-anisotropic fine metal particles using an electrolytic process is described in Mater. Lett. 2001, 49, 91-95, and a method for forming rod-shaped silver particles by microwave irradiation is described in J. Mater. Res. 2004, 19, 469-473. Furthermore, a method for forming shape-anisotropic fine metal particles using reverse micelle and ultrasonic wave is described in J. Phys. Chem. B, 2003, 107, 3679-3683.

Methods for forming gold particles are described in J. Phys. Chem. B, 1999, 103, 3073-3077, Langmuir 1999, 15, 701-709, and J. Am. Chem. Soc., 2002, 124, 14316-14317.

Rod-shaped particles may also be prepared by a method in which at least one condition (e.g., modification of addition amount or pH) in the methods described above is modified.

—Preparation of Irregular or Tabular Particles—

When the shape-anisotropic fine metal particles are irregular or tabular, the mainstream production method thereof is a reduction method conducted in an aqueous solution (chemical reduction of metal ions). Alternatively, such particles may be prepared by electroless plating, or metal vapor deposition. For example, silver fine particles (colloidal silver) can be prepared by any known method, such as a method of chemically reducing silver ions in a solution, including a method of reducing a soluble silver salt in an aqueous gelatin solution with hydroquinone disclosed in U.S. Pat. No. 2,688,601, a method of reducing a scarcely soluble silver salt with hydrazine described in German Patent 1,096,193, and a method of reducing silver ions to silver with tannic acid described in U.S. Pat. No. 2,921,914, a method of forming silver particles by electroless plating described in JP-A No. 5-134358, and a gas-phase vaporization method of evaporating a bulk metal in an inert gas such as helium gas and cold-trapping the metal in a solvent.

Hereinafter, an example of preparing irregular or tabular particles will be described.

—Preparation of Anisotropic Colloidal Silver Fine Particle Dispersion—

A dispersion containing irregular or tabular silver fine particles having a controlled average diameter can be prepared on the basis of the methods of the Examples in U.S. Pat. No. 2,688,601. Here, the pH value of the reaction system during silver salt reduction, the concentration of the dispersant solution, and/or the amount of the water-soluble calcium salt can be different from that in the patent. EFKA4550 manufactured by EFKA Additives may be used as the dispersant.

—Particle Diameter and Shape—

The dimension of each of the shape-anisotropic fine metal particles in the invention is defined by three axes. That is, a box (rectangular parallelopiped) which can closely accommodate a fine metal particle is imagined, and the dimension of the fine metal particle is defined by the length L, width b, and height or thickness t of the box. Although there are some manners for imagining such a virtual box accommodating the fine metal particle, the following method is adopted in the invention.

At first, a fine metal particle so placed on a plane as to make the height of its center of gravity the lowest and as to allow the particle to rest stably is imagined. Then, a first pair of parallel flat plates which are perpendicular to the plane, sandwich the fine metal particle and have the shortest distance therebetween is imagined. The distance is defined as “width b”. Next, a second pair of parallel flat plates which are perpendicular to both the first pair of parallel flat plates and the plane, and sandwich the particle is imagined. The distance between the flat plates of the second pair is defined as “length L”. Finally, a top plate which is parallel to the plane and brought into contact with the top of the fine metal particle is imagined. The distance between the top plate and the plane is defined as “height or thickness t”. (A rectangular parallelopiped box defined by the plane, the two pairs of flat plates and the top plate is imagined according to this method)

Of the width b, the length L and the height or thickness t of the fine metal particle, the longest axis is defined as a “major axis”. The length of the particle in the major-axis direction is defined as a “major-axis length”, and the diameter of a circle having an area the same as the projected area of the fine metal particle which projected area is obtained by irradiating the fine metal particle with light parallel to the major axis is defined as a “minor-axis length”.

The number-average diameter of the shape-anisotropic fine metal particles in the invention is not particularly limited, as long as it is not greater than the thickness of the film. However, the number-average diameter is preferably in the range of 10 to 1,000 nm, more preferably in the range of 10 to 500 nm, and still more preferably in the range of 10 to 200 nm. When the shape-anisotropic fine metal particles have a number-average diameter of 10 nm or more, such particles can be easily produced and a color filter including such fine metal particles does not have portions which, when visually observed, show dark browny (not black). In addition, the number-average diameter is preferably 1000 nm or less for improvement in stability of a particle dispersion and the light-shielding efficiency of the particles.

The “particle diameter” is the diameter of a circle having an area the same as the projected area of the electronically microscopic image of a particle, and the “number-average diameter” is obtained by randomly selecting 100 particles, measuring the diameter of each of these particles in the above manner and averaging the measured diameters.

In the invention, the volumetric metal rate (%) of the layer containing the shape-anisotropic fine metal particles is calculated by the following Formula: Volumetric metal rate (%)=(Metal volume/Layer volume)×100. For example, when the light-absorbing layer includes metal silver fine particles, the volumetric metal rate of the metal silver fine particles in the light-absorbing layer is calculated by calculating the total volume of the metal silver fine particles in the layer from the amount of the metal silver fine particles and silver's specific density of 10.5, and dividing the total volume by the total volume of the light-absorbing layer.

The volumetric metal rate (%) of the light-absorbing layer containing shape-anisotropic fine metal particles depends slightly on the type of the metal, but is preferably 5 to 30%, more preferably 10 to 28%, and most preferably 15 to 25% from the viewpoints of reductions in light reflectance and in the thickness of the light-absorbing layer, and a good light-shielding property.

—Aspect Ratio—

In the invention, the “aspect ratio” of the shape-anisotropic fine metal particles is defined as a value obtained by randomly selecting 100 shape-anisotropic fine metal particles, dividing the above-defined major-axis length of each of these shape-anisotropic fine metal particles by the corresponding minor-axis length, and averaging the calculated aspect ratios.

The projected area of a particle is obtained by measuring the area of the electronically microscopic image of the particle and correcting the area by the projection magnification of the image.

The average aspect ratio (ratio of the major-axis length of a particle to the minor-axis length of the particle) of the shape-anisotropic fine metal particles is preferably 1.2 or more and more preferably 1.5 or more. The upper limit of the aspect ratio is approximately 100. The reason why the aspect ratio is preferably 1.2 or more is to easily obtain black particles. It is preferable that the aspect ratio is not excessively high, in order to prevent decrease in absorption amount in the visible light region.

The average minor-axis length of the shape-anisotropic fine metal particles is preferably 4 to 50 nm, more preferably 15 to 50 nm, and most preferably 15 to 30 nm.

Moreover, the average major-axis length (maximum length) of the shape-anisotropic fine metal particles is preferably 10 to 1,000 nm, more preferably 100 to 1,000 nm, and still more preferably 400 to 800 nm, and most preferably less than the thickness of the coated film.

The absorption spectrum of the shape-anisotropic fine metal particles in the invention can be controlled and the tone of the particles can be made close to achromatic color by adjusting the aspect ratio. The aspect ratio is adjusted by mixing particles having different aspect ratios. For example, the tone of particles can be made close to achromatic color by blending particles having different aspect ratios. When an aqueous-phase reduction method is used to produce the shape-anisotropic fine metal particles, the aspect ratio can be adjusted by, for example, varying the pH of the reaction system, the kind of the reducing agent, the reaction temperature, and/or timing of addition.

The inventors of the invention found that the transmission density can be increased by using, for example, rod-shaped fine metal particles rather than spherical fine metal particles, and use of particles having such a shape allows the thickness of the light-shielding layer (light-shielding image) necessary to obtain sufficient light-shielding effect to be reduced.

—Particle Diameter Distribution—

The width of the number-average particle diameter distribution D90/D 10, which is obtained by approximating the particle-diameter distribution of the shape-anisotropic fine metal particles in the invention to normal distribution, is preferably at least 1.2 and less than 20. The value D90 is the maximum diameter of particles which account for 90% of all the particles with the number-average diameter as the center value, and the value D10 is the maximum diameter of particles which account for 10% of all the particles with the number-average diameter as the center value. The width of the particle-diameter distribution D90/D10 is more preferably 2 to 15, and still more preferably 4 to 10. When the distribution width is less than 1.2, the color tone may be close to monochrome. When it is 20 or more, such coarse particles may scatter light, generating turbidity.

The particle diameter distribution may be measured by, for example, a dynamic light-scattering/laser Doppler method (with, for example, NANOTRACK UPA-EX250 PARTICLE DIAMETER DISTRIBUTION ANALYZER manufactured by Nikkiso Co., Ltd., or COULTER N4 PLUS SUBMICRON PARTICLE DIAMETER DISTRIBUTION ANALYZER manufactured by Coulter); a disk high-speed centrifugal sedimentation method (with, for example, BI-DCP PARTICLE DIAMETER DISTRIBUTION ANALYZER manufactured by Nikkiso Co., Ltd.); or a laser diffraction/scattering method (with, for example, MICROTRAC MT3300 PARTICLE DIAMETER DISTRIBUTION ANALYZER manufactured by Nikkiso Co., Ltd., or LASER DIFFRACTION PARTICLE DIAMETER DISTRIBUTION ANALYZER SALD-7000 manufactured by Shimadzu Corporation); but the particle diameter distribution of nanometer-sized particles is preferably measured by a dynamic light-scattering/laser Doppler method.

<Reflectance>

In the invention, a reflectance at a wavelength of 555 nm, which is close to the peak of wavelengths of light to which human eyes are sensitive, is used.

Specifically, the reflectance is measured by irradiating an object with light whose incident direction is inclined with respect to the normal line by five degrees and which has a known intensity, measuring the intensity of the reflected light whose direction is inclined with respect to the normal line in the opposite direction by five degrees and calculating the ratio of the intensity I₀ of the incident light to that I of the reflected light according to the following expression of (I/I₀)×100 (%). However, if the measured intensity includes the intensity of light reflected by the substrate surface, the reflectance of the substrate is first measured, and a value obtained by correcting the calculated ratio on the basis of the reflectance of the substrate is regarded as the reflectance of the object. The reflectance of the light-absorbing layer is measured by forming the light-absorbing layer alone on a substrate and measuring the reflectance on the surface side of the light-absorbing layer which surface side is opposite to the substrate.

The reflectance of the light-absorbing layer tends to be high, when the shape-anisotropic fine metal particles contained in the layer are so close to each other that electron is easily interchanged therebetween, or are in contact with each other. For example, even when heated at a relatively low temperature of around 200° C., particles having a small and uniform diameter (10 nm) fuse and the reflectance of the layer becomes high. When the light-absorbing layer contains particles having different diameters within the range of 2 to 80 nm, the particles in the layer tend to be close to or in contact with each other and the light-absorbing layer tends to have a high reflectance in the film-forming process. Therefore, it is preferable to prevent fusion of these particles and increase in the reflectance.

The reflectance of the light-absorbing layer in the invention at a wavelength of 555 nm is preferably approximately 0.5 to approximately 30%, more preferably 1.0 to 30%, and most preferably 2.0 to 25%. When the light-absorbing layer having a high reflectance of more than 30% is included in, for example, a liquid crystal device, photoleak current due to reflection of backlight easily occurs, resulting in malfunction of a thin film transistor.

Preferably, the light-absorbing layer in the invention is patternwise formed from a photosensitive resin composition containing a resin component by a method that is low in environmental burden such as photolithography. The photosensitive resin composition will be described later.

Reflected Light-Absorbing Layer

The reflected light-absorbing layer in the invention has a function of absorbing light and absorbs light which enters at the reflected light-absorbing layer side and which is reflected at the interface between the reflected light-absorbing layer and the light-absorbing layer (An auxiliary layer may be disposed therebetween. This is true hereinafter). When the light-shielding image-carrying substrate has a layer structure which has a substrate, a reflected light-absorbing layer and a light-absorbing layer in that order, incident light (external light) entering through the substrate passes through the reflected light-absorbing layer, and is reflected at the interface of the reflected light-absorbing layer and the light-absorbing layer, and the reflected light is absorbed by the reflected light-absorbing layer. When the light-shielding image-carrying substrate has a layer structure which has a substrate, a light-absorbing layer and a reflected light-absorbing layer in that order, incident light entering at the backlight side (backlight, or external light passing through such regions other than the light-shielding layer as pixels and reflected by the substrate) passes through the reflected light-absorbing layer and is reflected at the interface of the reflected light-absorbing layer and the light-absorbing layer, and the reflected light is absorbed by the reflected light-absorbing layer. Reducing the amount of light which is derived from backlight and reflected at the interface and returns to the backlight side is effective in reducing brightness. The optical transmission density of the reflected light-absorbing layer can be measured with a Macbeth densitometer (TD-904 manufactured by Macbeth, and including a visual filter).

The thickness of the reflected light-absorbing layer is preferably 0.05 to 0.6 μm from the viewpoints of light-absorbing efficiency and easiness in production of a color filter, and more preferably 0.1 to 0.3 μm from the viewpoint of adjustment of a total film thickness to a desired value.

The optical transmission density is generally in the range of 0.3 to 3.0, preferably 0.3 to 2.0, more preferably 0.5 to 1.2, and still more 0.6 to 1.0.

To obtain the aforementioned function, the reflected light-absorbing layer in the invention preferably contains a light-absorbing substance (a colorant such as a pigment or a dye), and the light-absorbing substance is preferably dispersed in a resin.

Examples of the light-absorbing substance include carbon black, black pigments, pigment mixtures, and oxides containing at least one metal element selected from the group consisting of manganese, cobalt, iron, and copper. The light-absorbing substance preferably contains one or more of carbon black, pigment mixtures, and oxides containing at least one metal element selected from manganese, cobalt, iron, and copper; and more preferably contains carbon black and/or at least one of oxides containing at least one metal element selected from manganese, cobalt, iron, and copper. Carbon black may be surface-treated, as needed.

Typical examples of the dye include Monolite Fast Black B (C.I. Pigment Black 1); carbon; oxides of metals such as manganese and cobalt (e.g., Mn₃O₄, and Co₃O₄), iron and copper; and titanium black.

Preferably, the light-absorbing substance in the reflected light-absorbing layer in the invention is substantially uniformly dispersed in a resin layer. The particle diameter of the light-absorbing substance is preferably 5 μm or less and more preferably 1 μm or less. In preparing a color filter, the particle diameter is particularly preferably 0.5 μm or less from the viewpoint of dispersion stability.

The type of a dispersing machine used in dispersing the light-absorbing substance is not particularly limited, and the dispersing machine may be known one. Examples of such a machine include a kneader, a roll mill, an attritor, a super mill, a dissolver, a homomixer, and a sand mill.

A desired optical density of the reflected light-absorbing layer in the invention is determined, preferably considering the density of the light-absorbing layer.

When the reflected light-absorbing layer in the invention is formed as the layer closest to the substrate by a transfer method, the transfer material of the invention used to form the reflected light-absorbing layer preferably has so thermoplastic that the material softens at a temperature of 150° C. or lower, or adhesiveness. Most of layers formed from known photopolymerizable compositions have such a property. A part of the remaining may be modified by adding a thermoplastic binder or a compatible plasticizer thereto.

Examples of the resin component contained in the reflected light-absorbing layer in the invention include all of the known photosensitive resins described in JP-A No. 3-282404.

Typical examples thereof include photosensitive resin compositions each including at least one negative-type diazo resin and at least one binder, photopolymerizable resin compositions, photosensitive resin compositions each including at least one azide compound and at least one binder, and cinnamic acid—or a derivative thereof—containing photosensitive resin compositions. Among them, the resin component is preferably a photopolymerizable resin composition.

The photopolymerizable resin composition contains a photopolymerization initiator, a photopolymerizable monomer, and a binder as the basic components.

In producing the light-shielding image-carrying substrate, the photopolymerizable resin composition is preferably used. The reason for this is that, even when the resin composition is directly applied to the substrate, the coated film of the composition can stably adhere to the substrate. Further, the aforementioned resin component may also be used in producing the reflected light-absorbing layer and the auxiliary layer in the invention.

—Positional Relationship Between Reflected Light-Absorbing and Light-Absorbing Layers—

The reflected light-absorbing layer is preferably formed on the viewer side of the light-absorbing layer so as to effectively reduce the degree of reflection seen at the viewer side, and the reflected light-absorbing and light-absorbing layers are preferably formed on the substrate in that order.

In the case of a layer structure in which the substrate, the reflected light-absorbing layer and the light-absorbing layer are provided in that order, the reflected light-absorbing layer is also effective in absorbing light entering at the substrate (e.g., glass substrate) side, and absorbs external light entering at the substrate side and external light reflected at the interface between the reflected light- and light-absorbing layers. The total thickness of a light-shielding image having such a layer structure may be thinner than a light-shielding image having a conventional single-layered film.

Substrate

The substrate of the light-shielding image-carrying substrate according to the invention is, for example, a transparent substrate. Examples thereof include known glass plates such as a low-expansion glass plate, a non-alkali glass plate, a quartz glass plate and a soda-lime glass plate having a silicon oxide film on the surface thereof; and plastic films.

Auxiliary Layer

The light-shielding image-carrying substrate of the invention may have at least one auxiliary layer. The auxiliary layer(s) is preferably formed in the light-shielding image layer from the viewpoints of shock resistance, chemical resistance, and solvent resistance. Examples of the auxiliary layer include the following.

1. A layer formed between the substrate and the light-shielding image layer to improve adhesive force therebetween

2. A layer formed between the substrate and the resin layer or between the light-shielding image layer and the other layer to prevent reflection at the interface therebetween

3. A layer formed between the light-absorbing layer and the reflected light-absorbing layer to improve adhesive force therebetween

4. A layer formed on the light-shielding image layer to protect the light-shielding image layer

5. A layer formed and used to photolithographically pattern the light-shielding image layer

Typical examples of a layer structure having the auxiliary layer in the invention include, but are not limited to, a structure in which a substrate, a reflected light-absorbing layer, a light-absorbing layer, and an auxiliary layer are provided in that order, a structure in which a substrate, a reflected light-absorbing layer, an auxiliary layer, a light-absorbing layer and another auxiliary layer are provided in that order, and a structure in which a substrate, an auxiliary layer, a reflected light-absorbing layer, a light-absorbing layer and another auxiliary layer are provided in that order.

Photosensitive Resin Composition

The photosensitive resin compositions used to prepare the light-absorbing layer, the reflected light-absorbing layer, and the auxiliary layer in the invention will be described below.

When the light-absorbing layer in the invention is formed by coating, a photosensitive resin composition for a light-absorbing layer may be used.

<Photosensitive Resin Composition for Light-Absorbing Layer>

The photosensitive resin composition for a light-absorbing layer preferably contains shape-anisotropic fine metal particles and a photopolymerizable resin composition including a binder, a monomer or oligomer, and a photopolymerization initiator or initiator system.

A light-absorbing layer can be formed by coating the photosensitive resin composition on a substrate by a known method. Alternatively, the light-absorbing layer of a transfer material according to the invention can be formed by coating the photosensitive resin composition on a temporary support by a known method.

Examples of the types of the photopolymerizable resin composition contained in the photosensitive resin composition include those which can be developed with an aqueous alkaline solution and those which can be developed with an organic solvent. In the invention, the photopolymerizable resin composition is preferably developable with an aqueous alkaline solution, since such a composition does not require a facility for preventing pollution and that for ensuring occupational safety.

Hereinafter, the shape-anisotropic fine metal particles, the photopolymerizable resin composition, and a surfactant will be described in detail.

—Shape-Anisotropic Fine Metal Particles—

The photosensitive resin composition for a light-absorbing layer contains shape-anisotropic fine metal particles. The metal component thereof is the same as that of the shape-anisotropic fine metal particles in the aforementioned light-shielding image. Also, typical examples thereof are the same as those of the shape-anisotropic fine metal particles in the light-shielding image.

The concentration (volumetric rate (%) of the fine metal particles) of the shape-anisotropic fine metal particles in the photosensitive resin composition for a light-absorbing layer is preferably in the range of 0.01 to 70 mass %, and more preferably 0.1 to 40 mass % from the viewpoints of coatability, drying burden, and storage stability.

As for the diameter of the fine metal particles, the primary particle diameter of the fine metal particles is preferably preserved as it is in the coating solution from the viewpoint of stability of the coating solution.

The shape-anisotropic fine metal particles are preferably dispersed in the photosensitive resin composition for a light-absorbing layer. The dispersion state of the shape-anisotropic fine metal particles in the photosensitive resin composition is not particularly limited. However, it is preferable that the shape-anisotropic fine metal particles are stably dispersed. It is more preferable that the shape-anisotropic fine metal particles in the composition are in a colloidal state. When the shape-anisotropic fine metal particles are in the colloidal state, they are preferably so dispersed that they hardly agglomerate.

To disperse the shape-anisotropic fine metal particles in the photosensitive resin composition, the composition may include a dispersant. Examples of the dispersant include thiol group-containing compounds, amino acids and derivatives thereof, peptide compounds, polysaccharides and natural polymers derived therefrom, and synthetic polymers and gels derived therefrom.

The type of the thiol group-containing compound is not particularly limited. The compound has one or more thiol groups. Examples of the thiol group-containing compound include, but are not limited to, alkylthiols (e.g., methylmercaptan, and ethylmercaptan), arylthiols (e.g., thiophenol, thionaphthol, and benzylmercaptan), amino acids and derivatives thereof (e.g., cysteine, and glutathione), peptide compounds (e.g., cysteine residue-containing dipeptide compounds, tripeptide compounds, and tetrapeptide compounds, and oligopeptide compounds containing five or more amino acid residues), and proteins (e.g., metallothionein and spherical proteins having cysteine residues on the surface).

Examples of the aforementioned polymer serving as the dispersant include protective-colloid polymers such as gelatin, polyvinyl alcohol, methylcellulose, hydroxypropylcellulose, polyalkyleneamines, partial alkyl esters of polyacrylic acid, and PVP and PVP copolymers. The polymer used as the dispersant is described in, for example, “Dictionary of Pigments” (edited by Seijiro Itoh, and published by Asakura Shoin Co., Ltd. in 2000).

The photosensitive resin composition may further contain a hydrophilic polymer, a surfactant, an antiseptic, and/or a stabilizer. The hydrophilic polymer can be soluble in water and, when the concentration thereof is low, remains substantially dissolved in water. Otherwise it is not particularly limited. Examples thereof include natural polymers including proteins and substances derived therefrom such as gelatin, collagen, casein, fibronectin, laminin, and elastin, and polysaccharides and substances derived therefrom such as cellulose, starch, agarose, carrageenan, dextran, dextrin, chitin, chitosan, pectin, and mannan; synthetic polymers such as polyvinyl alcohol, polyacrylamide, polyacrylic acid, polyvinylpyrrolidone, polyethylene glycol, polystyrenesulfonic acid, and polyallylamine, and gels derived from the synthetic polymers. When gelatin is used as the hydrophilic polymer, the kind of gelatin used in the invention is not particularly limited. Examples thereof include alkali-treated cattle bone gelatin, alkali-treated porcine skin gelatin, acid-treated cattle bone gelatin, phthalated cattle bone gelatin, and acid-treated porcine skin gelatin.

The surfactant may be an anionic, cationic, nonionic, or betaine-type surfactant, and is preferably anionic or nonionic. The HLB value of the surfactant depends on whether the solvent of the coating solution is water-based or organic. The HLB is preferably approximately 8 to approximately 18 when the solvent is a water-based solvent, and is preferably approximately 3 to approximately 6 when it is an organic solvent.

The HLB value is described in, for example, “Surfactant Handbook” (edited by Tokiyuki Yoshida, Shinichi Shindo, and Shigeyosi Yamanaka, and published by Kougakutosho Ltd. in 1987). Typical examples of the surfactant include propylene glycol monostearic ester, propylene glycol monolauric ester, diethylene glycol monostearic ester, sorbitan monolaurylic ester, and polyoxyethylene sorbitan monolaurylic ester. Examples of the surfactant are also described in “Surfactant Handbook” described above.

The content of the surfactant is generally 0.1 to 20 mass % with respect to the total solid content (mass) in the photosensitive resin composition. The content is preferably 0.1 to 10 mass %, and more preferably 0.2 to 5 mass % from the viewpoints of interlayer adhesive force, foaming, and the properties of the coated surface.

—Photopolymerizable Resin Composition—

The photopolymerizable composition which can be developed with an aqueous alkaline solution and, together with the shape-anisotropic fine metal particles, contained in the photosensitive resin composition for a light-absorbing layer includes a binder, a monomer or oligomer, and a photopolymerization initiator or initiator system as described above.

—Binder—

The binder is preferably a polymer having at least one polar group such as carboxylic acid or carboxylate group in the side chain(s) thereof. Examples thereof include methacrylic acid copolymers, acrylic acid copolymers, itaconic acid copolymers, crotonic acid copolymers, maleic acid copolymers, and partially esterified maleic acid copolymers described in JP-A No. 59-44615, JP-B Nos. 54-34327, 58-12577, and 54-25957, and JP-A Nos. 59-53836 and 59-71048. The binder may also be a cellulose derivative having a carboxylic acid group on the side chain(s). Alternatively, the binder can be an adduct in which a cyclic acid anhydride is added to a hydroxyl group-containing polymer. Particularly favorable examples thereof include benzyl (meth)acrylate/(meth)acrylic acid copolymer and benzyl (meth)acrylate/(meth)acrylic acid/another monomer terpolymer described in U.S. Pat. No. 4,139,391. One of these polar group-containing binder polymers may be used alone or at least one of them can be used together with an ordinary film-forming polymer in the form of a composition.

The binder of the photosensitive resin composition for a light-absorbing layer preferably has an acid value in the range of 50 to 300 mgKOH/g from the viewpoints of developability and solubility in an organic solvent.

—Monomer or Oligomer—

The monomer or oligomer preferably has two or more ethylenically unsaturated double bonds and can be addition-polymerized by irradiation. Such a monomer and oligomer is, for example, a compound having at least one addition-polymerizable ethylenically unsaturated group in the molecule thereof and a boiling point of 100° C. or higher under atmospheric pressure. Examples thereof include monofunctional acrylates and methacrylates such as polyethylene glycol mono(meth)acrylate, polypropylene glycol mono(meth)acrylate and phenoxyethyl (meth)acrylate; and multifunctional acrylates and methacrylates such as polyethylene glycol di(meth)acrylate, polypropylene glycol di(meth)acrylate, trimethylolethane triacrylate, trimethylolpropane tri(meth)acrylate, trimethylolpropane diacrylate, neopentylglycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl) isocyanurate, tri(acryloyloxyethyl) cyanurate, glycerol tri(meth)acrylate, and compounds by adding ethylene oxide or propylene oxide to polyhydric alcohol such as trimethylolpropane or glycerol and (meth)acrylating the resultant adducts.

The monomer or oligomer can also be a urethane acrylate described in JP-B No. 48-41708 or 50-6034 or JP-A No. 51-37193; a polyester acrylate described in JP-A No. 48-64183 or JP-B No. 49-43191 or 52-30490; or a multifunctional acrylate or methacrylate such as epoxy acrylate that is a reaction product of an epoxy resin and (meth)acrylic acid.

Among them, the monomer or oligomer is preferably trimethylolpropane tri(meth)acrylate, pentaerythritol tetra(meth)acrylate, dipentaerythritol hexa(meth)acrylate, or dipentaerythritol penta(meth)acrylate.

Alternatively, the monomer or oligomer is preferably a “polymerizable compound B” described in JP-A No. 11-133600.

One of these monomers and oligomers may be used alone or two or more of them can be used together. The content thereof in all the solid components, except metal, of the photosensitive resin composition is generally 5 to 50 mass % and preferably 10 to 40 mass %.

The total content of the monomer(s) and/or oligomer(s) and the binder(s) in all the solid components except metal is preferably 30 to 90 mass %, more preferably 40 to 80 mass %, and still more preferably 50 to 70 mass %. The mass ratio of the monomer(s) and/or oligomer(s) to the binder(s) is preferably 0.5 to 1.2, more preferably 0.55 to 1.1, and still more preferably 0.6 to 1.0.

—Photopolymerization Initiator or Initiator System—

The photopolymerization initiator or the photopolymerization initiator system is, for example, a composition containing a halomethyloxadiazole compound or a halomethyl-s-triazine compound.

Examples of the photopolymerization initiator or the photopolymerization initiator system in the invention include vicinal polyketaldonyl compounds disclosed in U.S. Pat. No. 2,367,660, acyloin ether compounds described in U.S. Pat. No. 2,448,828, α-hydrocarbon-substituted aromatic acyloin compounds described in U.S. Pat. No. 2,722,512, polynuclear quinone compounds described in U.S. Pat. Nos. 3,046,127 and 2,951,758, a combination of a triarylimidazole dimer and a p-aminoketone described in U.S. Pat. No. 3,549,367, benzothiazole compounds and trihalomethyl-s-triazine compounds described in JP-B No. 51-48516, trihalomethyl-triazine compounds described in U.S. Pat. No. 4,239,850, and trihalomethyloxadiazole compounds described in U.S. Pat. No. 4,212,976. In particular, the photopolymerization initiator or initiator system is preferably trihalomethyl-s-triazine, trihalomethyloxadiazole or triarylimidazole dimer.

Alternatively, the photopolymerization initiator or initiator system is preferably a “polymerization initiator C” described in JP-A No. 11-133600.

One of these photopolymerization initiators and initiator systems may be used alone or two or more of them can be used together. However, use of two or more of the above compounds is particularly preferable. The content of the photopolymerization initiator in all the solid components of the photosensitive resin composition is generally 0.5 to 20 mass % and preferably 1 to 15 mass %.

A combination of a diazole photopolymerization initiator and a triazine photopolymerization initiator has high exposure sensitivity, a low degree of discoloration such as yellowing, and good display characteristics. Such a combination is most preferably a combination of 2-trichloromethyl-5-(p-styrylmethyl)-1,3,4-oxadiazole and 2,4-bis(trichloromethyl)-6-[4-(N,N-diethoxycarbonylmethylamino)-3-bromophenyl]-s-triazine.

The mass ratio of diazole to triazine is preferably 95/5 to 20/80, more preferably 90/10 to 30/70, and most preferably 80/20 to 60/40.

These photopolymerization initiators are described in JP-A Nos. 1-152449, 1-254918, and 2-153353.

Alternatively, the photopolymerization initiator is preferably a benzophenone compound.

The photopolymerizable composition for use in the invention is not limited to the above examples, and may be selected from known compounds.

When the photosensitive resin composition contains a coumarin compound as well as the photopolymerization initiator, such a composition has an effect similar to that of a photosensitive resin composition containing at least one pigment whose content in all the solid components of the photosensitive resin composition is about 15 to about 25 mass %. The coumarin compound is preferably 7-[2-[4-(3-hydroxymethylpiperidino)-6-diethylamino]triazinylamino]-3-phenylcoumarin.

The mass ratio of the photopolymerization initiator to the coumarin compound is preferably 20/80 to 80/20, more preferably 30/70 to 70/30, and most preferably 40/60 to 60/40.

The contents of the pigment, the multifunctional acrylate monomer, the carboxylic acid group-containing binder and the photopolymerization initiator in all the solid components is 10 to 50 mass %, 10 to 50 mass %, 20 to 60 mass %, and 1 to 20 mass %, respectively.

—Thermal Polymerization Initiator or Initiator System—

The photosensitive resin composition for a light-absorbing layer may contain a thermal polymerization initiator or initiator system in addition to the above components.

Examples of the thermal polymerization initiator or initiator system include radical initiators such as benzoyl peroxide and 2,2′-azobisisobutylonitrile, anionic polymerization initiators such as n-butyllithium, and cationic polymerization initiators such as SnCl₂.

The content of the thermal polymerization initiator or initiator system in all the solid components of the photosensitive resin composition is preferably 0.5 to 30 mass %, more preferably 1.0 to 20 mass %, and still more preferably 1.0 to 10 mass %.

—Thermal Polymerization Inhibitor—

The photosensitive resin composition for a light-absorbing layer may further contain a thermal polymerization inhibitor in addition to the above components.

Examples of the thermal polymerization inhibitor include hydroquinone, hydroquinone monomethyl ether, p-methoxyphenol, di-t-butyl-p-cresol, pyrogallol, t-butylcatechol, benzoquinone, 4,4′-thiobis(3-methyl-6-t-butylphenol), 2,2′-methylene-bis(4-methyl-6-t-butylphenol), 2-mercaptobenzimidazole, and phenothiazine.

The content of the thermal polymerization inhibitor in all the solid components of the photosensitive resin composition for a light-absorbing layer is generally 0.01 to 1 mass %, preferably 0.02 to 0.7 mass %, and more preferably 0.05 to 0.5 mass %.

—Solvent—

The photosensitive resin composition for a light-absorbing layer may contain a solvent. The type of the solvent is not particularly limited. Examples of the solvent include water, toluene, xylene, methyl ethyl ketone, methyl isobutyl ketone, acetone, methyl alcohol, n-propyl alcohol, 1-propyl alcohol, propylene glycol monomethyl ether, propylene glycol monomethyl ether acetate, cyclohexanone, cyclohexanol, ethyl lactate, methyl lactate, and caprolactam.

The photosensitive resin composition for a light-absorbing layer may further contain any other additive.

—Other Additives—

For example, the photosensitive resin composition for a light-absorbing layer (and a photosensitive resin composition for a reflected light-absorbing layer and that for an auxiliary layer described below) may contain a black or other pigment or dye, as needed.

When a pigment is contained, it is preferably dispersed uniformly in the photosensitive resin composition. To uniformly disperse the pigment in the composition, the diameters of the pigment particles are preferably 0.1 μm or less and more preferably 0.08 μm or less.

Examples of the black or other pigment and dye include Victoria Pure Blue BO (C.I. 42595), Auramine (C.I. 41000), Fat Black HB (C.I. 26150), Monolite Yellow GT (C.I. Pigment Yellow 12), Permanent Yellow GR (C.I. Pigment Yellow 17), Permanent Yellow HR (C.I. Pigment Yellow 83), Permanent Carmine FBB (C.I. Pigment Red 146), Hostaperm Red ESB (C.I. Pigment Violet 19), Permanent Ruby FBH (C.I. Pigment Red 11), Fast Pink B Supra (C.I. pigment Red 81), Monastral Fast Blue (C.I. Pigment Blue 15), Monolite Fast Black B (C.I. Pigment Black 1), carbon, C.I. Pigment Red 97, C.I. pigment Red 122, C.I. Pigment Red 149, C.I. Pigment Red 168, C.I. Pigment Red 177, C.I. Pigment Red 180, C.I. Pigment Red 192, C.I. pigment Red 215, C.I. Pigment Green 7, C.I. Pigment Blue 15:1, C.I. Pigment Blue 15:4, C.I. Pigment Blue 22, C.I. Pigment Blue 60, C.I. Pigment Blue 64, C.I. Pigment Violet 23, C.I. Pigment Blue 15:6, C.I. Pigment Yellow 139, C.I. Pigment Red 254, C.I. Pigment Green 36, and C.I. Pigment Yellow 138.

The photosensitive resin composition for a light-absorbing layer may contain a dispersant to improve the dispersing property and stability of the pigment.

The dispersant can be known one. Examples thereof include polyvinyl alcohol, acrylamide, sodium polyacrylate, sodium alginate, acrylamide/acrylic acid copolymer, and styrene/maleic anhydride copolymer. Alternatively, the dispersant can be an aliphatic silver compound such as silver stearate. Any of the dispersants described in “Pigment Dispersion Technology” (published by Technical Information Institute Co. Ltd. in 1999)” may also be used.

Photosensitive Resin Composition for Reflected Light-Absorbing Layer

The photosensitive resin composition for a reflected light-absorbing layer is the same as that for a light-absorbing layer, except that the shape-anisotropic fine metal particles are replaced with a light-absorbing substance. Other components of the photosensitive resin composition for a reflected light-absorbing layer are also the same as those of the photosensitive resin composition for a light-absorbing layer. The photosensitive resin composition for a reflected light-absorbing layer may further contain any other additive, if necessary.

The reflected light-absorbing layer in the invention needs to absorb reflected light and otherwise it is not particularly limited. Therefore, the reflected light-absorbing layer may be prepared by a method in which a film having a low reflectance and a multi-layered structure is produced by means of physical or chemical vapor deposition, or a method in which a film is formed using inorganic fine particles described in JP-A No. 6-43302, paragraph No. [0014] as well as a method using the photosensitive resin composition for a reflected light-absorbing layer.

Photosensitive Resin Composition for Auxiliary Layer

The photosensitive resin composition for an auxiliary layer is the same as the photosensitive resin composition for a light-absorbing layer, except that the photosensitive resin composition for an auxiliary layer does not contain shape-anisotropic fine metal particles. Other components of the photosensitive resin composition for an auxiliary layer are also the same as those of the photosensitive resin composition for a light-absorbing layer. The photosensitive resin composition for an auxiliary layer may further contain any other additive, if necessary.

The above-described photosensitive resin compositions serving as coating solutions are applied to a substrate and the resultant coatings are dried to form a photosensitive resin layer containing a light-absorbing layer and a reflected light-absorbing layer. Thereafter, other necessary steps are conducted. Thus, the light-shielding image in the invention is formed.

In the invention, the photosensitive resin composition are used to form the light-shielding image, which may be used as black matrixes such as the black frame formed at the periphery of display devices such as liquid crystal display devices, plasma display devices, EL display devices, and CRT display devices, the grid- or stripe-shaped black area at the interfaces of red, blue, and green pixels, and the dot- or line-shaped black pattern for protecting TFTs from light, as described above. The light-shielding image is preferably used in a liquid crystal display device.

Although a negative type photosensitive resin composition, in which only areas exposed to radioactive rays such as light or electron beam harden, is described above, the photosensitive resin composition in the invention may be a positive-type composition, in which only areas unexposed to radioactive rays harden.

The positive-type photosensitive resin composition can be a composition including a novolak resin. The novolak resin is, for example, one soluble in an alkali solution and described in JP-A No. 7-43899. Alternatively, the positive-type photosensitive resin composition can be one described in JP-A No. 6-148888, i.e., a photosensitive resin composition containing a resin soluble in an alkali solution, 1,2-naphthoquinonediazide sulfonic ester serving as a photosensitive agent, and a thermally hardening agent. Alternatively, the positive-type photosensitive resin composition can be a composition described in JP-A No. 5-262850.

<Transfer Material>

The transfer material according to the invention has a transfer layer on a temporary support. The transfer layer has at least two layers. At least one of the at least two layers is a reflected light-absorbing layer and at least one of the at least two layer is a light-absorbing layer containing shape-anisotropic fine metal particles. The transfer layer may contain at least one auxiliary layer.

In the transfer material according to the invention, at least one of the at least two layers is preferably a resin layer.

The transfer material according to the invention preferably has at least one thermoplastic resin layer and/or at least one intermediate layer to improve the transferring property and sensitivity of the transfer layer (e.g., light-absorbing and reflected light-absorbing layers). The transfer material may further contain a protective layer (protective film), and/or a releasing layer.

Temporary Support

The temporary support used in the transfer material according to the invention may be any of known supports such as polyester and polystyrene supports.

The thickness of the temporary support is preferably in the range of 15 to 200 μm and more preferably 30 to 150 μm. An excessively large thickness increases costs. On the other hand, a support having an excessively small thickness may deform due to heat during drying the applied layer or during the lamination step.

Preferably, the temporary support is flexible and, even when it undergoes pressure, or pressure and heat, resistant to drastic deformation, shrinkage and elongation. Examples of such a support include a polyethylene terephthalate film, a cellulose triacetate film, a polystyrene film, and a polycarbonate film. The temporary support is preferably a biaxially-stretched polyethylene terephthalate support from the viewpoints of strength, dimensional stability, chemical resistance, and cost.

Protective Film

The transfer material may have a thin protective film as the outermost layer of the at least two layers provided on the temporary support to protect the light-absorbing layer and the reflected light-absorbing layer from contamination and damage during storage. For example, the transfer material can have a thin protective film on the reflected light-absorbing layer.

The material of the protective film may be the same as or similar to that of the temporary support. However, since the protective film should be easily separated from the layer thereunder (e.g., the reflected light-absorbing layer or photosensitive resin layer), the protective film is preferably silicone paper or a polyolefin or polytetrafluoroethylene sheet (film), and more preferably a polyethylene or polypropylene film.

The thickness of the protective film is preferably approximately 5 to approximately 100 μm and more preferably 10 to 30 μm.

Transfer Layer

—Components of Light-Absorbing Layer, Reflected Light-Absorbing Layer, and Auxiliary Layer—

As described above, the transfer material according to the invention has at least two layers, including at least one light-absorbing layer and at least one reflected light-absorbing layer, and optionally including at least one auxiliary layer.

The components of the transfer layer and the amount and typical examples thereof are the same as in the case of the photosensitive resin compositions.

The above-described photosensitive resin compositions serving as coating solutions are applied to a temporary support and the resultant coatings are dried to form a photosensitive resin layer containing a light-absorbing layer and a reflected light-absorbing layer. Thereafter, other necessary steps are conducted. Thus, the light-shielding image in the invention is formed.

—Coating and Drying—

The photosensitive resin compositions can be coated with any known coating apparatus.

The coating method is not particularly limited, and is, for example, a spin-coating method described in JP-A No. 5-224011 or a die-coating method described in JP-A No. 9-323472. Alternatively, the coating method can be any of methods described in “Coating Engineering (written by Yuji Harazaki, and published by Asakura Publishing Company Ltd. in 1972)”.

In the invention, the coating is preferably performed with a coater which includes a nozzle having a slit in the portion from which a coating solution is jetted (slit coater).

Specifically, any of slit nozzles and slit coaters described in JP-A Nos. 2004-89851, 2004-17043, 2003-170098, 2003-164787, 2003-10767, 2002-79168, and 2001-310147 is preferably used in the invention.

The photosensitive resin compositions in the invention are coated on a temporary support with, for example, the nozzle or coater to obtain the transfer material according to the invention.

Thermoplastic Resin Layer

The transfer material according to the invention preferably has a thermoplastic resin layer.

The component of the thermoplastic resin layer is preferably an organic polymeric substance described in JP-A No. 5-72724, and is more preferably selected from organic polymeric substances having a softening point, measured by a Vicat method (specifically, a method of measuring the softening point of a polymer which method is stipulated in ASTM D1235), of approximately 80° C. or lower.

Typical examples thereof include polyolefins such as polyethylene and polypropylene; ethylene copolymers such as ethylene/vinyl acetate copolymer and saponified products thereof, and ethylene/acrylic ester copolymer and saponified products thereof; polyvinyl chloride; vinyl chloride copolymers such as vinyl chloride/vinyl acetate copolymer and saponified products thereof; polyvinylidene chloride; vinylidene chloride copolymers; polystyrene; styrene copolymers such as styrene/(meth)acrylic ester copolymer and saponified products thereof; polyvinyltoluene; vinyltoluene copolymers such as vinyltoluene/(meth)acrylic ester copolymer and saponified products thereof; poly(meth)acrylic ester; (meth)acrylic ester copolymers such as butyl (meth)acrylate/vinyl acetate copolymer; and polyamide resins such as vinyl acetate/nylon copolymer, other nylon copolymers, N-alkoxymethylated nylons, and N-dimethylaminated nylons.

Two (resins A and B) of these resins are preferably used together in the following manner.

The resin A preferably has a weight-average molecular weight in the range of 50,000 to 500,000 and a glass transition temperature (Tg) of 0 to 140° C., and more preferably a weight-average molecular weight in the range of 60,000 to 200,000 and a glass transition temperature (Tg) of 30 to 110° C.

Such a resin is, for example, methacrylic acid/2-ethylhexyl acrylate/benzyl methacrylate/methyl methacrylate copolymer described in JP-A No. 63-147159.

The resin B preferably has a weight-average molecular weight in the range of 3,000 to 30,000 and a glass transition temperature (Tg) of 30 to 170° C. and more preferably a weight-average molecular weight in the range of 4,000 to 20,000 and a glass transition temperature (Tg) of 60 to 140° C.

Such a resin is, for example, a styrene/(meth)acrylic acid copolymer described in JP-A No. 5-241340.

When the resin A of the thermoplastic resin layer has a weight-average molecular weight of lower than 50,000 or a glass transition temperature (Tg) of lower than 0° C., reticulation of the resin may occur, or the thermoplastic resin may run out of during transfer and may stain the temporary support.

When the resin A has a weight-average molecular weight of more than 500,000 or a glass transition temperature (Tg) of higher than 140° C., lamination fitness thereof may deteriorate.

The thickness of the thermoplastic resin is preferably in the range of 1 to 50 μm and more preferably 2 to 20 μm.

When the thickness of the thermoplastic resin is less than 1 μm, lamination fitness thereof may deteriorate. When the thickness is more than 50 μm, cost increases and productivity may deteriorate.

The solvent of the coating solution for a thermoplastic resin layer in the invention needs to dissolve the resin of the layer and otherwise it is not limited. The solvent can be methyl ethyl ketone, n-propanol, and/or iso-propanol.

Intermediate Layer <Oxygen-Blocking Layer>

An alkali-soluble intermediate layer is preferably formed between the thermoplastic resin layer and the photosensitive resin layer (e.g., light-absorbing layer) of the transfer material according to the invention so as to prevent the thermoplastic and photosensitive resin layers from mixing with each other during coating. The layer preferably has a function of blocking oxygen to ensure photopolymerization of the photopolymerizable composition. In this case, the layer also has functions of raising efficiency in initiating photopolymerization and enhancing sensitivity, and is called an “oxygen-blocking layer”.

The resin of the intermediate layer needs to be alkali-soluble and otherwise it is not particularly limited.

Examples of the resin include polyvinyl alcohol resins, polyvinyl pyrrolidone resins, cellulosic resins, acrylamide resins, polyethylene oxide resins, gelatin, vinyl ether resins, and polyamide resins, and copolymers thereof. In addition, the resin can be a copolymer obtained by copolymerizing a resin that is usually alkali-insoluble, such as polyester, with a monomer having a carboxyl or sulfonate group to solubilize the resin in an alkali solution.

The resin of the intermediate layer is preferably polyvinyl alcohol. The saponification value of polyvinyl alcohol is preferably 80% or more and more preferably 83 to 98%.

The intermediate layer preferably contains a mixture of two or more resins, especially a mixture of polyvinyl alcohol and polyvinyl pyrrolidone. The mass ratio of polyvinyl pyrrolidone to polyvinyl alcohol is preferably in the range of 1/99 to 75/25 and more preferably 10/90 to 50/50. When the mass ratio is less than 1/99, the surface state of the intermediate layer may deteriorate and the intermediate layer may not sufficiently adhere to the light reflectance layer formed thereon. When the mass ratio is more than 75/25, the oxygen-blocking property of the intermediate layer may deteriorate and consequently, sensitivity of the transfer material may decrease.

The thickness of the intermediate layer is preferably in the range of 0.1 to 5 μm and more preferably 0.5 to 3 μm. When the thickness is less than 0.1 μm, the oxygen-blocking property may deteriorate. When the thickness is more than 5 μm, removing the intermediate layer at the time of development requires lengthened time.

The solvent of a coating solution for the intermediate layer needs to dissolve the above resin and otherwise it is not particularly limited. The solvent is preferably water, and can also be a mixture of water and a water-miscible organic solvent (e.g., alcohol).

Typical examples of the solvent of a coating solution for the intermediate layer include water, a mixture of water and methanol having a mass ratio of 90/10, a mixture of water and methanol having a mass ratio of 70/30, a mixture of water and methanol having a mass ratio of 55/45, a mixture of water and ethanol having a mass ratio of 70/30, a mixture of water and 1-propanol having a mass ratio of 70/30, a mixture of water and acetone having a mass ratio of 90/10, and a mixture of water and methyl ethyl ketone having a mass ratio of 95/5.

Method of Preparing Transfer Material

The transfer material (photosensitive resin transfer material) preferably used in the invention can be prepared as follows. The components of a thermoplastic resin layer are dissolved in a solution to prepare a coating solution (coating solution for a thermoplastic resin layer). The coating solution is applied to a temporary support and the resultant coating is dried to form a thermoplastic resin layer on the temporary support. Thereafter, a coating solution for an intermediate layer containing the components of an intermediate layer and a solvent that does not dissolve the thermoplastic resin layer is applied to the thermoplastic resin layer, and the resultant coating is dried. Finally, coating solutions for photosensitive resin layers containing the components of photosensitive resin layers and a solvent that does not dissolve the intermediate layer is applied to the intermediate layer and the resultant coating is dried.

Alternatively, the transfer material may also be prepared by separately producing a sheet having a thermoplastic resin layer and an intermediate layer on a temporary support and a sheet having photosensitive resin layers (i.e., light-absorbing and reflected light-absorbing layers) on a protective film, and laminating these sheets in such a manner that the intermediate layer is in contact with one of the photosensitive resin layers.

Alternatively, the transfer sheet may also be prepared by separately producing a sheet having a thermoplastic resin layer on a temporary support and a sheet having photosensitive resin layers and an intermediate layer on a protective film, and laminating these sheets in such a manner that the intermediate layer is in contact with the thermoplastic resin layer.

The transfer material according to the invention can be used in various applications, and is preferably used to prepare the above-described light-shielding image, the black matrix of devices described later, and color filter described later.

Method of Forming Light-Shielding Image

Hereinafter, methods of forming a light-shielding image will be described.

<Light-Shielding Image Production Method Using Transfer Material>

A method of forming a light-shielding image in which method the transfer layer of the transfer material according to the invention is transferred onto a substrate will be described hereinafter.

The method of forming a light-shielding image according to the invention includes: providing a transfer sheet having at least two resin layers on a temporary support, transferring the at least two resin layers on the temporary support onto a substrate, patternwise exposing the resin layers, and developing the resin layers patternwise exposed to remove the unexposed area(s) thereof.

Hereinafter, this method will be described specifically.

Transfer

In the transfer, the at least two resin layers (light-absorbing and reflected light-absorbing layers) on the temporary support are preferably brought into close contact with a substrate so as to laminate these layers on the substrate.

The lamination may be performed by any known method. The lamination can be performed with, for example, a laminator or a vacuum laminator at a temperature in the range of 60 to 150° C., a pressure of 0.2 to 20 kg/cm², and a line speed of 0.05 to 10 m/minute. In the invention, the temporary support is preferably separated from the at least resin layers after the lamination.

—Adhesion by Laminator—

The film-shaped photosensitive resin layer of the photosensitive resin transfer material can be bonded to the substrate by, for example, heating and/or pressurization with a roller, or a flat plate for pressurization or for heating and pressurization.

Specifically, the lamination may be performed by the laminator and the lamination method described in JP-A No. 7-110575, 11-77942, 2000-334836, or 2002-148794. The lamination is preferably performed by the method described in JP-A No. 7-110575, since the degree of contamination due to foreign matters is low.

Substrate

The substrate used in the production method according to the invention is the same as that of the aforementioned light-shielding image-carrying substrate.

The substrate can be treated with a coupling agent to improve the adhesion between the substrate and the photosensitive resin transfer material.

The coupling treatment described in JP-A No. 2000-39033 is preferably conducted.

Exposure

To improve exposure sensitivity in the exposure of the method for preparing a light-shielding image according to the invention, the resultant laminated body to be exposed preferably has an intermediate layer having an oxygen-blocking function.

The light source for use in the exposure is selected suitably according to the photosensitivity of the light-shielding transfer layer (light-absorbing and reflected light-absorbing layers). The light source can be any known one such as an ultrahigh-pressure mercury lamp, a xenon lamp, a carbon arc lamp, or an argon laser. An optical filter whose transmittance with respect to light having a wavelength of 400 nm or more is 2% or less, such as an optical filter described in JP-A No. 6-59119, may be used together with the light source.

The exposure method may be a batch exposure method of exposing the entire substrate surface once, or a division exposure method of sequentially exposing the divided portions of the substrate one by one. Alternatively, an exposure method of scanning the substrate surface with a laser may be used. Here, an exposure mask having an image pattern such as a quartz exposure mask is preferably used.

Development

In the development in the invention, a developing solution may be used. The developing solution can be a dilute aqueous solution of an alkaline substance, and may further contain a water-miscible organic solvent in a small amount.

Typical examples of the alkaline substance include alkali metal hydroxides (e.g., sodium hydroxide and potassium hydroxide), alkali metal carbonates (e.g., sodium carbonate and potassium carbonate), alkali metal bicarbonates (e.g., sodium bicarbonate and potassium bicarbonate), alkali metal silicates (e.g., sodium silicate and potassium silicate), alkali metal metasilicates (e.g., sodium metasilicate and potassium metasilicate), triethanolamine, diethanolamine, monoethanolamine, morpholine, tetraalkylammonium hydroxides (e.g., tetramethylammonium hydroxide), and trisodium phosphate.

The concentration of the alkaline substance in the developing solution is preferably 0.01 to 30 mass %, and the pH of the developing solution is preferably 8 to 14.

The property or properties of the developing solution such as pH can be adjusted according to the property or properties, such as oxidation state, of the transfer layer (light-absorbing and reflected light-absorbing layers) so as to ensure development in which the unexposed portions of the transfer layer (resin layers) are removed in the form of films.

Typical examples of the water-miscible organic solvent include methanol, ethanol, 2-propanol, 1-propanol, butanol, diacetone alcohol, ethylene glycol monomethylether, ethylene glycol monoethylether, ethylene glycol mono-n-butylether, benzylalcohol, acetone, methylethylketone, cyclohexanone, ε-caprolactone, γ-butylolactone, dimethylformamide, dimethylacetamide, hexamethylphosphoramide, ethyl lactate, methyl lactate, ε-caprolactam, and N-methylpyrrolidone. The concentration of the water-miscible organic solvent is preferably 0.1 to 30 mass %.

The developing solution may further contain a known surfactant. The concentration of the surfactant is preferably 0.01 to 10 mass %.

The developing solution may be applied or sprayed. For removal of the unhardened portions of the transfer layer in the form of solid, preferably films, the transfer material is preferably rubbed with a rotating brush or a wet sponge in the developing solution. Alternatively, the developing solution may be pressurized and sprayed on the transfer material.

The temperature of the developing solution is preferably in the range of around room temperature to 40° C. The substrate may be washed with water after the development.

The processing solution for the thermoplastic resin layer and the developing solution for the photosensitive resin layer may not be the same, and may have different compositions.

Baking

The substrate may be heated after the developing step, if necessary. This treatment can accelerate hardening of the photosensitive resin layer (light-shielding layer) partly hardened by exposure and can enhance the solvent resistance and alkali resistance of the photosensitive resin layer.

The substrate after development can be heated, for example, in an electric furnace or a dryer, or with an infrared lamp. Desired heating temperature and time depend on the composition and the thickness of the photosensitive resin layer (light-shielding layer). However, the heating is generally conducted at a temperature in the range of 120° C. to 300° C. for 10 to 300 minutes, preferably 120° C. to 250° C. for 10 to 300 minutes, and more preferably 180 to 240° C. for 30 to 200 minutes.

Post Exposure

In addition, the substrate after the developing step may be exposed to light before the heat treatment in order to accelerate hardening of the photosensitive resin layer. The exposure may be performed in the same manner as the first exposure.

Patterning

In the invention, a process for obtaining a light-shielding image or pixel shape is called patterning. The patterning is conducted by exposure and development of a photosensitive resin layer. Such a patterning method is called photolithography or a photolithographic method.

The light-shielding image may also be formed on a substrate as follows. A photosensitive resin composition for a reflected light-absorbing layer is applied to a substrate and the resultant coating is dried. Furthermore, a photosensitive resin composition for a light-absorbing layer is applied to the reflected light-absorbing layer and the resultant coating is dried to form at least two resin layers (reflected light-absorbing and light-absorbing layers) on the substrate. These resin layers are imagewise exposed to light (patterned) through an exposure mask, and the exposed resin layer is developed to remove the unexposed portions.

The substrate, and exposure and development methods are the same as those of the method for forming a light-shielding image using a transfer material. The coating and drying conditions can be the same as those of the method of preparing a transfer material.

Color Filter

The color filter according to the invention has the light-shielding image-carrying substrate described above and pixels of two or more colors, for example, red, blue and green pixels.

The method of forming pixels is not particularly limited. Any known method including photolithography, etching, and printing may be used. These methods are described in, for example, “Production Methods and Chemicals of Color Filters (supervised by Junji Watanabe, and published by CMC Publishing in 1998)”.

Among the methods, photolithography is preferable. Typical methods thereof include the following.

A first method using a photosensitive resin composition (resist solution) containing a pigment or a dye.

In this method, a color filter is prepared as follows. A photosensitive resin composition (resist solution) is applied to a substrate and the resultant coating is dried. The coating is exposed to light through a photomask and the exposed coating is developed. These processes are repeated, while the color of the pigment or dye contained in the photosensitive resin composition is changed. The repeating times correspond to a desired number of colors of the pixels.

A second method using a transfer material having a photosensitive resin layer (transfer layer) containing a pigment or a dye.

In this method, a color filter is prepared as follows. A transfer material is laminated on a substrate, exposed to light through a photomask and developed. These processes are repeated, while the color of the pigment or dye contained in the photosensitive resin layer is changed. The repeating times correspond to a desired number of colors of the pixels.

The arrangement of the pixels (RGB pixel pattern) of the color filter according to the invention is not particularly limited, and the pixels are arranged in a stripe, block, check or other pattern. The method of forming pixels may also be used to form TFTs having an uneven surface. The arrangement is described in, for example, “Production Methods and Chemicals of Color Filters (supervised by Junji Watanabe, and published by CMC Publishing in 1998)”, p. 14.

The chromaticity range of the color filter according to the invention is the same as that of conventional color filters. The chromaticity range and the relevant backlight are also described in, for example, “Production Methods and Chemicals of Color Filters (supervised by Junji Watanabe, and published by CMC Publishing in 1998)”, p. 15.

The color filter according to the invention should have such properties as heat resistance, light resistance, chemical resistance, surface smoothness, and hardness, which are required for the light-shielding image.

Typical examples of methods for preparing the color filter according to the invention include those described in JP-A Nos. 2004-317898, 2004-317899, 2004-240039, 2004-219809, and 2004-347831.

Display Device

The display device according to the invention has the light-shielding image-carrying substrate according to the invention and the color filter according to the invention.

The display device according to the invention can be applied to a liquid crystal display device, a plasma display device, an EL display device, and a CRT display device.

The definition of display devices and explanations of each display device are described in, for example, “Electronic Display Device (written by Akio Sasaki, and published by Kogyo Chosakai Publishing Inc. in 1990)”, and “Display Devices (written by Naotaka Ibuki, and published by Sangyo Tosho in 1989)”.

The display device according to the invention is preferably a liquid crystal display device. Liquid crystal display devices are described in, for example, “Next-Generation Liquid Crystal Display Technology (edited by Tatsuo Uchida, and published by Kogyo Chosakai Publishing Inc. in 1994)”. Application of the display device according to the invention (liquid crystal display device) is not particularly limited, and the display device can be preferably applied to liquid crystal devices described in, for example, “Next-Generation Liquid Crystal Display Technology” and driven in various modes. Among them, the invention is particularly effective in color TFT liquid crystal display devices.

The color TFT liquid crystal display devices are described in, for example, “Color TFT Liquid Crystal Displays (published by Kyoritsu Shuppan Co., Ltd. in 1996)”. The display device according to the invention may also be applied to liquid crystal display devices with an extended angle of visibility, for example, those driven in a horizontal electric field drive mode such as IPS and those driven in a pixel division mode such as MVA. These modes are described in, for example, “Current Trend in Technology and Market of EL, PDP, and LCD displays” (published by Toray Research Center Inc., Technical Survey Dept. in 2001)” p. 43.

The display device according to the invention generally includes various members such as an electrode substrate, a polarization film, a phase difference film, a backlight, a spacer, a film compensating an angle of visibility, an anti-reflection film, a light-diffusing film, and an anti-dazzle film as well as the color filter. The light-shielding image according to the invention can be applied to liquid crystal display devices containing these known members. These members are described in, for example, “Market of Liquid Crystal Display-related Materials and Chemicals in 1994 (written by Kentaro Shima, and published by CMC Publishing in 1994)”, and “Current Status and Future Prospect of Liquid Crystal-related Market (2nd vol.) (written by Ryokichi Omote, and published by Fuji Chimera Research Institute, Inc. in 2003)”; and examples of LCDs include STN, TN, VA, IPS, OCS, and R-OCB.

### EXAMPLES

Hereinafter, the invention will be described more specifically, but it should be understood that the invention is not restricted by these examples. “Part” and “%” described below means “parts by mass” and “mass %”, unless specified otherwise.

### Example 1

### Preparation of Light-Shielding Image-Carrying Substrate

<Preparation of Transfer Material>

A coating solution for a thermoplastic resin layer having the following composition H1 was coated on a polyethylene terephthalate film serving as a temporary support and having a thickness of 75 μm with a slit-shaped nozzle and the resultant coating was dried at 100° C. for 3 minutes to obtain a thermoplastic resin layer having a dry thickness of 5 μm.

Then, a coating solution for an intermediate layer having the following composition P1 was coated on the thermoplastic resin layer with a slit coater and the resultant coating was dried at 100° C. for 3 minutes to obtain an intermediate layer having a dry thickness of 1.5 μm

A coating solution for a light-absorbing layer containing fine metal particles and having the following composition A1 was coated on the intermediate layer with a slit coater so that the optical density of the resultant layer was 3.8. Further, a coating solution for a reflected light-absorbing layer having the following composition B1 was coated on the light-absorbing layer with a slit coater so that the optical density of the resultant layer was 0.6. These coatings were dried at 100° C. for 3 minutes.

In this manner, a film in which the temporary support, the thermoplastic resin layer, the intermediate layer (oxygen-blocking film), the light-absorbing layer, and the reflected light-absorbing layer were integrated was prepared. A protective film (polypropylene film having a thickness of 12 μm) was pressed against and bonded to the reflected light-absorbing layer to obtain a transfer material.

Coating Solution for Thermoplastic Resin Layer: Composition H1
Methanol 11.1 parts
Propylene glycol monomethyl ether acetate 6.36 parts
Methyl ethyl ketone 52.4 parts
Methyl methacrylate/2-ethylhexyl acrylate/benzyl methacrylate/methacrylic acid copolymer (copolymerization composition ratio (molar ratio) of 55/11.7/4.5/28.8, weight-average molecular weight of 90,000, and Tg of about 70° C.) 5.83 parts
Styrene/acrylic acid copolymer (copolymerization composition ratio (molar ratio) of 63/37, weight-average molecular weight of 80,000, and Tg of about 100° C.) 13.6 parts
Dehydration condensation product from one equivalence of bisphenol A and two equivalences of pentaethylene glycol monomethacrylate (BPE-500 manufactured by Shin-Nakamura Chemical) 9.1 parts
Surfactant 1 (MEGAFAC F-780-F manufactured by Dainippon Ink and Chemicals, Inc.) 0.54 parts

Coating Solution for Intermediate Layer: Composition P1
Polyvinyl alcohol (PVA105 manufactured by Kuraray Co., Ltd.) 4.3 parts
Distilled water 50.7 parts
Methyl alcohol 45.0 parts

Coating Solution for Light-Absorbing Layer: Composition A1
Anisotropic colloidal silver fine particle dispersion liquid (having a particle diameter of 80 nm, and prepared as described below) 6.0 parts
n-Propyl alcohol 18.0 parts
Methyl ethyl ketone 6.0 parts
Dipentaerythritol hexaacrylate (KAYARAD DPHA manufactured by Nippon Kayaku Co., Ltd.) 0.209 parts
Bis[4-[N-[4-(4,6-bistrichloromethyl-s-triazine-2-yl)phenyl]carbamoyl]phenyl] sebacate 0.01 parts
Methacrylic acid/allyl methacrylate copolymer (molar ratio of 20/80, and weight-average molecular weight of 40,000) 0.11 parts
Fluorochemical surfactant (MEGAFAC F-780-F manufactured by Dainippon Ink and Chemicals, Inc.) 0.085 parts
   <Preparation of Anisotropic Colloidal Silver Fine Particle Dispersion Liquid>

The anisotropic colloidal silver fine particle dispersion liquid used in Example 1 was prepared as follows.

A dispersion liquid in which silver fine particles having an average diameter of 80 nm were dispersed was obtained in the same manner as in Examples of U.S. Pat. No. 2,688,601, except that the pH of a system during reduction of a silver salt, the concentration of a dispersant solution, and the amount of a water-soluble calcium salt were changed. The content of silver in the dispersion liquid was 10 mass %. The dispersion liquid was centrifuged at 4,000 rpm for 30 minutes and the supernatant was removed. n-Propylalcohol was added to the residue, and the resultant mixture was stirred with a paint shaker to give a silver fine particle dispersion liquid containing 20 mass % of silver, 2 mass % of a dispersant, 11 mass % of water, and 67 mass % of n-propyl alcohol.

The dispersant used here was EFKA4550 manufactured by EFKA Additives BV. The silver particle dispersion liquid contained irregular silver fine particles and tabular silver fine particles at a ratio of 7:3.

Anisotropic colloidal silver fine particle dispersion liquids used in Examples 7 to 12, and 14 to 19 having average diameters of silver fine particles and ratios of irregular particles to tabular particles respectively different from those in Example 1) were also prepared on the basis of the above preparation method. These dispersion liquids had a silver content of 10 mass %.

Coating Solution for Reflected Light-Absorbing Layer: Composition B1
Benzyl methacrylate/methacrylic acid copolymer (molar ratio of 73/27, viscosity of 0.12, and weight-average molecular weight of 38,000) 37.9 parts
Dipentaerythritol hexaacrylate 29.1 parts
Bis[4-[N-[4-(4,6-bistrichloromethyl-s-triazine-2-yl)phenyl]carbamoyl]phenyl] sebacate 1.7 parts
Carbon black (black) (NIPX35 manufactured by Degussa AG) 30.1 parts
Methylcellosolve acetate 560 parts
Methyl ethyl ketone 280 parts
   <Preparation of Light-Shielding Image-Carrying Substrate by Transfer Using Transfer Material (Transfer Method)>

The protective film of the transfer material was removed. Thereafter, the transfer material was placed on a glass substrate (thickness: 1.1 mm), with the reflected light-absorbing layer brought into contact with the glass substrate. These were bonded with a laminator (LAMIC II manufactured by Hitachi Industries Co., Ltd.) at a pressure of 0.8 Pa at a temperature of 130° C. Then, the polyethylene terephthalate temporary support was removed from the bonded structure.

A mask (quartz exposure mask having an image pattern) and the resultant were disposed vertically and parallel to each other so that the thermoplastic resin layer faced the mask. The distance between the photosensitive resin layer (reflected light-absorbing layer/light-absorbing layer) and the exposure mask was set at 200 μm. The resultant material was patternwise exposed to light from a proximity-type exposure machine (manufactured by Hitachi High-Tech Electronics Engineering Co., Ltd.) equipped with an ultrahigh-pressure mercury lamp through the mask at a light exposure of 300 mJ/cm².

The above material was shower-developed with a triethanolamine developing solution at 30° C. for 58 seconds at a flat nozzle pressure of 6.15/0.02 MPa. Thus, the thermoplastic resin and the intermediate layer were removed.

Pure water was sprayed on the resultant with a shower nozzle to uniformly wet the surface of the light-absorbing layer. Then, the resultant was shower-developed with a solution obtained by diluting KOH developing solution (CDK-1 containing KOH and a nonionic surfactant, and manufactured by Fuji Film Electronic Materials Co., Ltd.) 100 times at 23° C. for 80 seconds at a flat nozzle pressure of 0.04 MPa. Thus, a patterned image was obtained.

Subsequently, the residue was removed by spraying ultrapure water on the image with an ultrahigh-pressure cleaning nozzle at a pressure of 9.8 MPa. Thus, a light-shielding image was obtained. The resultant material was heated at 220° C. for 30 minutes to give a light-shielding image-carrying substrate. The screen size of the black matrix pattern was 10 inch, and the number of pixels was 480×640. The width of each black line of the black matrix was 24 μm, and the size of the opening for each pixel was 86 μm×304 μm.

### Example 2

A light-shielding image-carrying substrate was prepared as follows.

<Preparation of Light-Shielding Image-Carrying Substrate by Application Method Using Slit and Spin Coater>

The aforementioned coating solution having the composition B1 was applied to a glass substrate with a slit nozzle. The glass substrate was rotated to make the thickness of the resultant coating layer uniform. The layer was then dried until it lost fluidity. Thereafter, the unnecessary portion of the coating solution which adhered to the circumferential surface of the substrate was removed. The layer was then prebaked at 120° C. for 3 minutes. Thus, a reflected light-absorbing layer was formed. The thickness of the reflected light-absorbing layer was such that the optical density was 0.8.

The aforementioned coating solution for a light-absorbing layer having the composition A1 was applied to the reflected light-absorbing layer with a slit and a spin coater and the resultant coating layer was dried at 100° C. for 3 minutes to obtain a light-absorbing layer having a dry thickness of 0.24 μm.

Next, the aforementioned coating solution for an intermediate layer (oxygen-blocking layer) having the composition P1 was applied to the light-absorbing layer with a slit and a spin coater and the resultant coating layer was dried at 100° C. for 3 minutes to obtain an intermediate layer having a dry thickness of 1.6 μm.

A mask (quartz exposure mask having an image pattern) and the resultant material were disposed vertically and parallel to each other so that the light-absorbing layer faced the mask. The distance between the photosensitive resin layer (light-absorbing layer) and the exposure mask was set at 200 μm. The material was patternwise exposed to light from a proximity-type exposure machine (manufactured by Hitachi High-Tech Electronics Engineering Co., Ltd.) equipped with an ultrahigh-pressure mercury lamp through the mask at a light exposure of 300 mJ/cm².

Pure water was sprayed on the material with a shower nozzle to uniformly wet the surface of the photosensitive resin layer (light-absorbing layer). Then, the material was shower-developed with a solution obtained by diluting KOH developing solution (CDK-1 containing KOH and a nonionic surfactant, and manufactured by Fuji Film Electronic Materials Co., Ltd.) 100 times at 23° C. for 80 seconds at a flat nozzle pressure of 0.04 MPa. Thus, a patterned image was obtained. Subsequently, the residue was removed by spraying ultrapure water on the image with an ultrahigh-pressure cleaning nozzle at a pressure of 9.8 MPa. Thus, a light-shielding image was obtained. The resultant was then heated at 220° C. for 30 minutes to give a light-shielding image-carrying substrate. The thickness of the light-shielding image was 0.58 μm.

### Example 3

A light-shielding image-carrying substrate was formed as follows.

<Preparation of Light-Shielding Image-Carrying Substrate by Coating Method Using Slit-Shaped Nozzle>

A no-alkali glass substrate was cleaned with a UV cleaning machine, cleaned with a brush and a detergent, and further cleaned with ultrasonic waves in ultrapure water. The substrate was heated at 120° C. for 3 minutes to stabilize the surface thereof.

The substrate was then cooled down and conditioned at 23° C. Thereafter, the aforementioned coating solution for a reflected light-absorbing layer having the composition B1 was applied thereto with a rotor for a glass substrate (MH-1600 manufactured by FAS Japan) having a slit-shaped nozzle.

The layer was dried with a vacuum dryer (VCD manufactured by Tokyo Ohka Kogyo Co., Ltd.) for 30 seconds to remove a part of the solvent contained in the layer. Here, the layer was dried until it lost fluidity. The unnecessary portion of the coating solution which adhered to the circumferential surface of the substrate was removed with an edge-bead-remover (EBR), and the layer was prebaked at 120° C. for 3 minutes to obtain a reflected light-absorbing layer. The thickness of the reflected light-absorbing layer was such that the optical density thereof was 1.0. A light-absorbing layer was formed in the same manner as the reflected-light-absorbing layer, except that the coating layer was changed to the aforementioned coating solution for a light-absorbing layer having the composition A1.

A mask (quartz exposure mask having an image pattern) and the resultant material were disposed vertically and parallel to each other so that the light-absorbing layer faced the mask. The distance between the photosensitive resin layer (light-absorbing layer) and the exposure mask was set at 200 μm. The material was patternwise exposed to light from a proximity-type exposure machine (manufactured by Hitachi High-Tech Electronics Engineering Co., Ltd.) equipped with an ultrahigh-pressure mercury lamp through the mask at a light exposure of 300 mJ/cm².

Pure water was sprayed on the material with a shower nozzle to uniformly wet the surface of the photosensitive resin layer (light-absorbing layer). Then, the material was shower-developed with a solution obtained by diluting KOH developing solution (CDK-1 containing KOH and a nonionic surfactant, and manufactured by Fuji Film Electronic Materials Co., Ltd.) 100 times at 23° C. for 80 seconds at a flat nozzle pressure of 0.04 MPa. Thus, a patterned image was obtained. Subsequently, the residue was removed by spraying ultrapure water on the image with an ultrahigh-pressure cleaning nozzle at a pressure of 9.8 MPa. Thus, a light-shielding image was obtained. The resultant was then heated at 220° C. for 30 minutes to give a light-shielding image-carrying substrate. The thickness of the light-shielding image was 0.67 μm.

### Example 4

A light-shielding image-carrying substrate having a substrate, a reflected light-absorbing layer, a light-absorbing layer and an anti-reflection layer in that order was formed in the same manner as in Example 1, except that a coating solution for an anti-reflection layer having the following composition C1 was applied to the light-absorbing layer to form an anti-reflection layer (auxiliary layer) and the thickness of each of the reflected light-absorbing and light-absorbing layers was so changed as to obtain the optical density shown in Table 2.

Coating Solution for Anti-Reflection Layer (Coating Solution for Auxiliary Layer): Composition C1
Benzyl methacrylate/methacrylic acid copolymer (molar ratio of 73/27, and viscosity of 0.12) 37.9 parts
Dipentaerythritol hexaacrylate 29.1 parts
Bis[4-[N-[4-(4,6-bistrichloromethyl-s-triazine-2-yl)phenyl]carbamoyl]phenyl] sebacate 1.7 parts
Carbon black (black) 30.1 parts
Methylcellosolve acetate 560 parts
Methyl ethyl ketone 280 parts

### Example 5

A light-shielding image-carrying substrate was prepared in the same manner as in Example 1, except that the content of carbon black in the coating solution for a reflected light-absorbing layer having the composition B1 was doubled, and the thickness of each of the reflected light-absorbing and light-absorbing layers was so changed as to obtain the optical density shown in Table 2.

### Example 6

A light-shielding image-carrying substrate was prepared in the same manner as in Example 1, except that the carbon black in the coating solution for a reflected light-absorbing layer having the composition B1 was replaced with NANOTECH Mn oxide (manufactured by C.I. Kasei Co.) and the thickness of each of the reflected light-absorbing and light-absorbing layers was so changed as to obtain the optical density shown in Table 2.

### Example 7

A light-shielding image-carrying substrate was prepared in the same manner as in Example 1, except that the silver particles contained in the anisotropic colloidal silver fine particle dispersion liquid in the coating solution for a light-absorbing layer having the composition A1 were changed to those shown in Table 2 and no intermediate layer was formed.

### Examples 8 to 11

Light-shielding image-carrying substrates were prepared in the same manner as in Example 1, except that the silver particles contained in the anisotropic colloidal silver fine particle dispersion liquid in the coating solution for a light-absorbing layer having the composition A1 were changed respectively to those shown in Tables 2 and 3 and the thickness of each of the reflected light-absorbing and light-absorbing layers was so changed as to obtain the optical density shown in Table 2 or 3.

### Example 12

An image-carrying substrate was prepared in the same manner as in Example 1, except that the anisotropic colloidal silver fine particle dispersion liquid in the coating solution for a light-absorbing layer having the composition A1 was replaced with a rod-shaped colloidal silver fine particle dispersion liquid prepared by the following method and the thickness of each of the reflected light-absorbing and light-absorbing layers was so changed as to obtain the optical density shown in Table 3.

<Preparation of Rod-Shaped Colloidal Silver Fine Particle Dispersion Liquid>

A dispersion liquid of rod-shaped silver fine particles having an average aspect ratio of 3 (minor axis length of 60 nm, and major axis length of 180 nm) was prepared on the basis of a method of producing fine particles described in “Mater. Chem. Phys., 2004, 84, pp 197-204, while the pH of a system during silver salt reduction and the reaction temperature were changed and the ratio of the amount of seed particles to that of a metal salt were so adjusted as to obtain a desired aspect ratio. The dispersion liquid was centrifuged at 10,000 rpm for 20 minutes and the supernatant was removed. The residue was concentrated. Thus, rod-shaped silver fine particles were obtained.

n-Propylalcohol was added to the rod-shaped silver fine particles, and the resultant mixture was stirred with an ultrasonic dispersing machine (ULTRASONIC GENERATOR MODEL US-6000 CCVP manufactured by Nissei) to give a silver fine particle dispersion liquid containing 20 mass % of silver, 2 mass % of a dispersant, 11 mass % of water, and 67 mass % of n-propylalcohol. The dispersant used was EFKA4550 manufactured by EFKA Additives BV.

### Examples 13 to 17

Image-carrying substrates were prepared in the same manner as in Example 1, except that the silver particles contained in the anisotropic colloidal silver fine particle dispersion liquid in the coating solution for a light-absorbing layer having the composition A1 were changed respectively to those shown in Tables 3 and the thickness of at least one of the reflected light-absorbing and light-absorbing layers was so changed as to obtain the optical density shown in Table 3.

### Comparative Example 1

An image-carrying substrate was prepared in the same manner as in Example 1, except that no reflected light-absorbing layer was formed and the silver content in the anisotropic colloidal silver fine particle dispersion liquid was changed to 60 vol %, and the contents of the other raw materials were in proportion to the silver content.

### Example 18

### Liquid Crystal Display Device

A light-shielding image-carrying substrate was prepared in the same manner as in each of Examples 1-17 and Comparative Example 1 and Liquid crystal display devices including the light-shielding image-carrying substrates were prepared as follows.

Each of the light-shielding image-carrying substrates had a black matrix pattern having a pixel size of 10 inch and the number of pixels of 480×640. The width of each black line of the black matrix was 24 μm, and the size of an opening for each pixel area was 86 μm×304 μm.

<Preparation of Photosensitive Transfer Material>

A photosensitive transfer material for forming red pixels R1, a photosensitive transfer material for forming green pixels G1, and a photosensitive transfer material for forming blue pixels B1 each having a laminated structure of PET temporary support/thermoplastic resin layer/intermediate layer/photosensitive layer (R1, G1, or B1)/protective film were prepared in the same manner as in Example 1, except that the coating solution for a reflecting light-absorbing layer and that for a light-absorbing layer were replaced with colored photosensitive resin compositions R1, G1, and B1 having the following compositions shown in Table 1.

TABLE 1

| | Unit: part | | |
|---|---|---|---|
| Colored photosensitive resin composition | R1 | G1 | B1 |
| K pigment dispersion 1 | — | — | — |
| R pigment dispersion 1 | 44 | — | — |
| (C.I.P.R.254) | | | |
| R pigment dispersion 2 | 5.0 | — | — |
| (C.I.P.R.177) | | | |
| G pigment dispersion 1 | — | 24 | — |
| (C.I.P.G.36) | | | |
| Y pigment dispersion 1 | — | 13 | — |
| (C.I.P.Y.150) | | | |
| B pigment dispersion 1 | — | — | 7.2 |
| (C.I.P.B.15:6) | | | |
| B pigment dispersion 2 | — | — | 13 |
| (C.I.P.B.15:6 + C.I.P.V.23) | | | |
| Propylene glycol monomethyl ether acetate | 7.6 | 29 | 23 |
| Methyl ethyl ketone | 37 | 26 | 35 |
| Cyclohexanone | — | 1.3 | — |
| Binder 1 | — | 3 | — |
| Binder 2 | 0.76 | — | — |
| Binder 3 | — | — | 17.3 |
| DPHA liquid | 4.4 | 4.3 | 3.8 |
| 2-Trichloromethyl-5-(p-styrylmethyl) | 0.13 | 0.15 | 0.15 |
| 1,3,4-oxadiazole | | | |
| 2,4-Bis(trichloromethyl)-6-[4-(N,N- | 0.06 | 0.06 | — |
| diethoxycarbonylmethyl)-3-bromophenyl]-s- | | | |
| triazine | | | |
| Phenothiazine | 0.01 | 0.005 | 0.02 |
| Hydroquinone monomethyl ether | — | — | — |
| ED152 | 0.52 | — | — |
| Surfactant 1 | 0.03 | 0.07 | 0.05 |

*Each component in Table 1 will be described below in detail.

<Preparation of Liquid Crystal Display Device>
—Formation of Red (R) Image—

Red pixels (R pixels) were formed on the black matrix side of each of the light-shielding image-carrying substrates in the same manner as the light-shielding image described in the section <Preparation of light-shielding image-carrying substrate by transfer using transfer material (transfer method)> of Example 1, except that the photosensitive transfer material was replaced with the photosensitive transfer material R1, and the light exposure in the exposure step was changed to 40 mJ/cm², and the developing step was performed at 35° C. for 35 seconds, and the baking step was conducted at 220° C. for 20 minutes.

The thickness of the photosensitive layer R1 was 2.0 μm, and the coating amounts of C.I. Pigment Red (C.I.P.R.) 254 and C.I.P.R. 177 were respectively 0.88 g/m² and 0.22 g/m².

The light-shielding image-carrying substrate having the R pixels was cleaned with a brush and a detergent, shower-washed with pure water, and heated with a substrate-preheating apparatus at 100° C. for 2 minutes without use of a silane-coupling agent solution.

—Formation of Green (G) Image—

Then, green pixels (G pixels) were formed on the side of the light-shielding image-carrying substrate which side had the black matrix and the red pixels in the same manner as the red pixels, except that the photosensitive transfer material R1 was replaced with the photosensitive transfer material G1, and the developing step was performed at 34° C. for 45 seconds.

The thickness of the photosensitive layer G1 was 2.0 μm, and the coating amounts of C.I. Pigment Green (C.I.P.G.) 36 and C.I. Pigment Yellow (C.I.P.Y.) 150 were respectively 1.12 g/m² and 0.48 g/m².

The light-shielding image-carrying substrate having the R and G pixels was cleaned with a brush and a detergent, shower-washed with pure water, and heated with the substrate-preheating apparatus at 100° C. for 2 minutes without use of a silane-coupling agent solution.

—Formation of Blue (B) Image—

Further, blue pixels (B pixels) were formed on the side of the light-shielding image-carrying substrate which side had the black matrix and the red and green pixels in the same manner as the red pixels, except that the photosensitive transfer material R1 was replaced with the photosensitive transfer material B1, and the light exposure in the exposure step was changed to 30 mJ/cm², and the developing step was performed at 36° C. for 40 seconds, and the baking process was not conducted.

The thickness of the photosensitive layer B1 thickness was 2.0 μm, and the coating amounts of the C.I. Pigment Blue (C.I.P.B.) 15:6 and C.I. Pigment Violet (C.I.P.V) 23 were respectively 0.63 g/m² and 0.07 g/m².

The light-shielding image-carrying substrate having the R, G and B pixels was cleaned with a brush and a detergent, shower-washed with pure water, and heated with the substrate-preheating apparatus at 100° C. for 2 minutes without use of a silane-coupling agent solution.

After formation of the B pixels, the light-shielding image-carrying substrate having the R, G, and B pixels was heated at 240° C. for 50 minutes to give a desired color filter substrate.

Hereinafter, methods of preparing the colored photosensitive resin compositions R1, G1, and B 1 shown in Table 1 will be described respectively.

Preparation of Colored Photosensitive Resin Composition R1

The colored photosensitive resin composition R1 was prepared as follows. The amounts, shown in Table 1, of R pigment dispersion 1, R pigment dispersion 2, and propylene glycol monomethyl ether acetate were weighed out and these were mixed at a temperature of 24° C. (±2° C.) and agitated at 150 rpm for 10 minutes. The amounts, shown in Table 1, of methyl ethyl ketone, binder 2, DPHA liquid, 2-trichloromethyl-5-(p-styrylmethyl)-1,3,4-oxadiazole, 2,4-bis(trichloromethyl)-6-[4-(N,N-diethoxycarbonylmethyl)-3-bromophenyl]-s-triazine, and phenothiazine were weighed out, and these were added to the above mixture in the above order at a temperature of 24° C. (±2° C.). The resultant blend was agitated at 150 rpm for 30 minutes. Then, the amount, shown in Table 1, of ED152 was weighed out and weighed ED152 was added to the blend at a temperature 24° C. (±2° C.). The resultant admixture was agitated at 150 rpm for 20 minutes. In addition, the amount, shown in Table 1, of a surfactant 1 was weighed out and the surfactant was added to the admixture at a temperature of 24° C. (±2° C.). The resultant mixture was agitated at 30 rpm for 30 minutes, and filtered through a nylon mesh #200.

The composition of each of the components of the composition R1 shown in Table 1 is as follows.
Composition of R pigment dispersion 1
C.I. Pigment Red 254 8.0 parts
N,N′-bis-(3-diethylaminopropyl)-5-(4-[2-oxo-1-(2-oxo-2,3-dihydro-1H-benzimidazole-5-ylcarbamoyl)-propylazo]-benzoylamino)-isophthalamide 0.8 parts
Benzyl methacrylate/methacrylic acid random copolymer (molar ratio of 72/28, and weight-average molecular weight of 37,000)) 8 parts
Propylene glycol monomethyl ether acetate 83.2 parts
Composition of R pigment dispersion 2
C.I. Pigment Red 177 18 parts
Benzyl methacrylate/methacrylic acid random copolymer (molar ratio of 72/28, and weight-average molecular weight of 37,000)) 12 parts
Propylene glycol monomethyl ether acetate 70 parts
Composition of binder 2
Benzyl methacrylate/methacrylic acid/methyl methacrylate random terpolymer (molar ratio of 38/25/37, and weight-average molecular weight of 30,000) 27 parts
Propylene glycol monomethyl ether acetate 73 parts
Composition of DPHA liquid
Dipentaerythritol hexaacrylate (containing a polymerization inhibitor MEHQ in an amount of 500 ppm)(KAYARAD DPHA manufactured by Nippon Kayaku Co., Ltd.) 76 parts
Propylene glycol monomethyl ether 24 parts
Composition of surfactant 1
Copolymer of C₆F₁₃CH₂CH₂OCOCH═CH₂ (40 parts), H(O(CH₃)CHCH₂)₇OCOCH═CH₂ (55 parts) and H(OCH₂CH₂)₇OCOCH═CH₂ (5 parts), (weight-average molecular weight of 30,000) 30 parts
Methyl isobutyl ketone 70 parts
ED152
HIPLAAD ED152 (manufactured by Kusumoto Chemicals, Ltd.)
   Preparation of Colored Photosensitive Resin Composition G1

The colored photosensitive resin composition G1 was prepared as follows. The amounts, shown in Table 1, of G pigment dispersion 1, Y pigment dispersion 1, and propylene glycol monomethyl ether acetate were weighed out and these were mixed at a temperature of 24° C. (±2° C.) and agitated at 150 rpm for 10 minutes. The amounts, shown in Table 1, of methyl ethyl ketone, cyclohexanone, binder 1, DPHA liquid, 2-trichloromethyl-5-(p-styrylmethyl)-1,3,4-oxadiazole, 2,4-bis(trichloromethyl)-6-[4-(N,N-diethoxycarbonylmethyl)-3-bromophenyl]-s-triazine, and phenothiazine were weighed out, and these were added to the above mixture in the above order at a temperature of 24° C. (±2° C.). The resultant blend was agitated at 150 rpm for 30 minutes. Then, the amount, shown in Table 1, of a surfactant 1 was weighed out and the surfactant was added to the blend at a temperature of 24° C. (±2° C.). The resultant mixture was agitated at 30 rpm for 5 minutes, and filtered through a nylon mesh #200.

The composition of each of the components of the composition G1 shown in Table 1 is as follows.
Composition of G pigment dispersion 1
C.I. Pigment Green 36 18 parts
Benzyl methacrylate/methacrylic acid random copolymer (molar ratio of 72/28, and weight-average molecular weight of 37,000)) 12 parts
Cyclohexanone 35 parts
Propylene glycol monomethyl ether acetate 35 parts
Y pigment dispersion 1

CF YELLOW EX3393 (manufactured by Mikuni Color Co., Ltd.)
Composition of binder 1
Benzyl methacrylate/methacrylic acid random copolymer (molar ratio of 78/22, and weight-average molecular weight of 44,000)) 27 parts
Propylene glycol monomethyl ether acetate 73 parts

Preparation of Colored Photosensitive Resin Composition B1

The colored photosensitive resin composition B1 was prepared as follows. The amounts, shown in Table 1, of B pigment dispersion 1, B pigment dispersion 2, and propylene glycol monomethyl ether acetate were weighed out and these were mixed at a temperature of 24° C. (±2° C.) and agitated at 150 rpm for 10 minutes. The amounts, shown in Table 1, of methyl ethyl ketone, binder 3, DPHA liquid, 2-trichloromethyl-5-(p-styrylmethyl)-1,3,4-oxadiazole, and phenothiazine were weighed out, and these were added to the above mixture in the above order at a temperature of 25° C. (±2° C.). The resultant blend was agitated at a temperature of 40° C. (±2° C.) at 150 rpm for 30 minutes. Then, the amount, shown in Table 1, of a surfactant 1 was weighed out and the surfactant was added to the blend at a temperature of 24° C. (±2° C.). The resultant mixture was agitated at 30 rpm for 5 minutes, and filtered through a nylon mesh #200.

The composition of each of the components of the composition B1 shown in Table 1 is as follows.
B pigment dispersion 1

CF BLUE EX3357 (manufactured by Mikuni Color Co., Ltd.)
B pigment dispersion 2

CF BLUE EX3383 (manufactured by Mikuni Color Co., Ltd.)
Composition of binder 3
Benzyl methacrylate/methacrylic acid/methyl methacrylate random terpolymer (molar ratio of 36/22/42, and weight-average molecular weight of 30,000) 27 parts
Propylene glycol monomethyl ether acetate 73 parts

—Preparation of Liquid Crystal Display Device—

A liquid crystal display device was prepared by combining the color filter substrate, a drive-side substrate and a liquid crystal material. A TFT substrate having TFTs and pixel electrodes (electrically conductive layers) was provided as the drive-side substrate. The pixel electrode-formed surface of the TFT substrate and the surface of the color filter substrate were disposed so that they faced each other. A liquid crystal material was confined in the space between these surfaces, forming a liquid crystal layer responsible for image display. A polarization plate HLC2-2518 manufactured by Sanritsu Corp. was adhered to each face of each of the resultant liquid crystal cells. Then, a backlight in a side-lighting mode including a red (R) LED, FR1112 H (chip-type LED manufactured by Stanley Electronic Co., Ltd.), a green (G) LED, DG1112H (chip-type LED manufactured by Stanley Electronic Co., Ltd.), and a blue (B) LED, DB1112H (chip-type LED manufactured by Stanley Electronic Co., Ltd.) was connected to the rear face of the liquid crystal cells having the polarization plates.

Evaluation

The samples thus obtained were evaluated as follows. Results are summarized in Tables 2 and 3.

<Measurement of Film Thickness>

The thickness of each of the images formed after the baking was measured with a non-contact surface roughness meter P-10 (manufactured by TENCOR).

<Measurement of Optical Transmission Density>

The optical transmission density of a film (reflected light-absorbing layer, light-absorbing layer, or reflected light-absorbing layer and light-absorbing layer) was measured according to the following method:

First, a photosensitive light-shielding layer (reflected light-absorbing layer, light-absorbing layer, or reflected light-absorbing layer and light-absorbing layer) formed on a glass substrate was exposed to light emitted by an ultrahigh-pressure mercury lamp at an intensity of 500 mJ/cm² from the photosensitive light-shielding layer side. Then, the optical density (O.D.) of the layer was measured with a Macbeth densitometer (TD-904 manufactured by Macbeth). Separately, the optical density of the glass substrate (OD₀) was measured in the same manner as the above. The value obtained by subtracting OD₀ from O.D. was defined as the optical transmission density of the film.

<Color Tone>

The color tone of each sample was observed visually from the glass substrate side (the face having no coated film) under an indoor fluorescent lamp.

<Measurement of Reflectance>

The absolute reflectance of the entire substrate was measured on the glass substrate side (the face having no coated film) with an absolute reflectance measuring device ARV-474 (manufactured by JASCO Corp.) used in combination with a spectrophotometer V-560 (manufactured by JASCO Corp.). In addition, the absolute reflectance of the light-absorbing layer was measured on the other side of the substrate (the face on which the coated film was formed). The measurement angle was five degrees with respect to the vertical direction, and the wavelength of the light used in the measurement was 555 nm.

<Shape-Anisotropic Fine Metal Particles>

—Measurement of Particle-Diameter Distribution (D90/D10)—

The number average diameter of particles was calculated from the unimodal average (normal distribution approximation) in particle-diameter distribution histogram analysis and a submicron particle-diameter distribution analyzer COULTER N4 PLUS manufactured by Coulter. The maximum diameter of particles which accounted for 90% of all the particles with the number average diameter as the center value was designated as D90, and the maximum diameter of particles which accounted for 10% of all the particles with the number average diameter as the center value was designated as D10, and the ratio D90/D10 was calculated.

—Measurement of Aspect Ratio—

The major axis length and minor axis length of each of one hundred shape-anisotropic fine metal particles were obtained from their electronically microscopic images, and the ratio of the major axis length to the minor axis length of each particle was calculated and the resultant ratios were averaged.

—Measurement of Particle Diameter (nm)—

Images obtained by magnifying one hundred particles under a transmission electron microscope (TEM (JEM-2010) having a magnification of 200,000 times, and manufactured by JEOL) were obtained. The diameter of a circle having an area the same as the projected area of each of the images was regarded as the particle diameter of the corresponding particle. The diameters obtained were averaged.

—Measurement of Volumetric Metal Ratio—

The volumetric metal ratio was calculated according to the following formula: (metal volume/entire volume)*100=volumetric metal ratio (%). Here, the value 10.5 was used as the specific density of silver.

<Malfunction of Device>

Part of light from LCDs serving as the backlight is reflected on the surface of the black matrix layer and directed into TFTs, causing leakage light during black display. The presence of such leakage light was regarded as malfunction. Presence or absence of leakage light is shown in Tables 2 and 3. Whether leakage light occurred was checked in a dark place.

TABLE 2

| Sample No. | | | | | |
|---|---|---|---|---|---|
| Example | Example | Example | Example | Example | Example |
| 1 | 2 | 3 | 4 | 5 | 6 |
| Method of forming light-shielding image | | | | | |
| Transfer | Applica- | Applica- | Transfer | Transfer | Transfer |
| method | tion | tion | method | method | method |

Reflected light-absorbing layer

| Light-absorbing substance | | C.B | C.B | C.B | C.B | C.B | Mn |
|---|---|---|---|---|---|---|---|
| | | | | | | | oxide |
| Optical transmission density | | 0.60 | 0.80 | 1.00 | 0.60 | 0.60 | 0.60 |
| Film thickness (μm) | | 0.26 | 0.34 | 0.43 | 0.26 | 0.13 | 0.30 |
| Light-absorbing layer | | | | | | | |
| Absolute reflectance of this layer | | 15% | 15% | 15% | 15% | 15% | 15% |
| alone (%) | | | | | | | |
| Optical transmission density | | 3.8 | 3.8 | 3.8 | 3.8 | 3.8 | 3.8 |
| Shape- | Kind | Silver | Silver | Silver | Silver | Silver | Silver |
| anisotropic | | particle | particle | particle | particle | particle | particle |
| fine metal | Particle-diameter | 2.5 | 2.5 | 2.5 | 2.5 | 2.5 | 2.5 |
| particles | distribution | | | | | | |
| | D90/D10 | | | | | | |
| | Aspect ratio | 2.5 | 2.5 | 2.5 | 2.5 | 2.5 | 2.5 |
| | Particle diameter | 80 | 80 | 80 | 80 | 80 | 80 |
| | (nm) | | | | | | |
| | Minor axis (nm) | — | — | — | — | — | — |
| | Major axis (nm) | — | — | — | — | — | — |
| | Shape (irregular | 7:3 | 7:3 | 7:3 | 7:3 | 7:3 | 7:3 |
| | particles: tabular | | | | | | |
| | particles) | | | | | | |
| | Volumetric metal | 17.6 | 17.6 | 17.6 | 17.6 | 17.6 | 17.6 |
| | ratio (%) | | | | | | |

| | | | | | | |
|---|---|---|---|---|---|---|
| Color tone | Black | Black | Black | Black | Black | Black |
| Film thickness (μm) | 0.24 | 0.24 | 0.24 | 0.24 | 0.24 | 0.24 |

Reflected light-absorbing layer +
Light-absorbing layer

| Entire optical transmission density | 4.4 | 4.6 | 4.8 | 4.4 | 4.4 | 4.4 |
|---|---|---|---|---|---|---|
| Entire film thickness | 0.50 | 0.58 | 0.67 | 0.50 | 0.37 | 0.54 |
| Optical transmission density per | 8.8 | 7.9 | 7.2 | 8.8 | 11.9 | 8.1 |
| unit thickness | | | | | | |
| (optical transmission | | | | | | |
| density/entire thickness) | | | | | | |
| Reflectance on glass face side | 0.90% | 0.90% | 0.90% | 0.90% | 0.90% | 0.90% |
| Auxiliary layer | | | | | | |
| Antireflection film | Absence | Absence | Absence | Presence | Absence | Absence |
| Intermediate layer | Presence | Presence | Presence | Presence | Presence | Presence |
| (oxygen-blocking film layer) | | | | | | |
| Malfunction of device | Absence | Absence | Absence | Absence | Absence | Absence |

| | | Sample No. | | | |
|---|---|---|---|---|---|
| | | Example | Example | Example | Example |
| | | 7 | 8 | 9 | 10 |
| | | Method of forming light-shielding image | | | |
| | | Transfer | Transfer | Transfer | Transfer |
| | | method | method | method | method |
| Reflected light-absorbing layer | | | | | |
| Light-absorbing substance | | C.B | C.B | C.B | C.B |
| Optical transmission density | | 0.60 | 0.60 | 0.60 | 0.60 |
| Film thickness (μm) | | 0.26 | 0.26 | 0.26 | 0.26 |
| Light-absorbing layer | | | | | |
| Absolute reflectance of this layer | | 14% | 14% | 10% | 9% |
| alone (%) | | | | | |
| Optical transmission density | | 3.2 | 3.3 | 4.0 | 3.1 |
| Shape- | Kind | Silver | Silver | Silver | Silver |
| anisotropic | | particle | particle | particle | particle |
| fine metal | Particle-diameter | 4.0 | 2.3 | 1.8 | 1.7 |
| particles | distribution | | | | |
| | D90/D10 | | | | |
| | Aspect ratio | 6.0 | 2.2 | 1.8 | 3.0 |
| | Particle diameter | 60 | 70 | 110 | 200 |
| | (nm) | | | | |
| | Minor axis (nm) | — | — | — | — |
| | Major axis (nm) | — | — | — | — |
| | Shape (irregular | 8:2 | 8:2 | 3:7 | 2:8 |
| | particles: tabular | | | | |
| | particles) | | | | |
| | Volumetric metal | 17.6 | 17.6 | 17.6 | 17.6 |
| | ratio (%) | | | | |

| Color tone | Black | Black | Black | Black |
|---|---|---|---|---|
| Film thickness (μm) | 0.24 | 0.24 | 0.24 | 0.24 |
| Reflected light-absorbing layer + | | | | |
| Light-absorbing layer | | | | |
| Entire optical transmission density | 3.8 | 3.9 | 4.6 | 3.7 |
| Entire film thickness | 0.50 | 0.50 | 0.50 | 0.50 |
| Optical transmission density per | 7.6 | 7.8 | 9.2 | 7.4 |
| unit thickness | | | | |
| (optical transmission | | | | |
| density/entire thickness) | | | | |
| Reflectance on glass face side | 0.90% | 0.90% | 0.90% | 0.90% |
| Auxiliary layer | | | | |
| Antireflection film | Absence | Absence | Absence | Absence |
| Intermediate layer | Absence | Presence | Presence | Presence |
| (oxygen-blocking film layer) | | | | |
| Malfunction of device | Absence | Absence | Absence | Absence |

TABLE 3

| Sample No. | | | | | | | |
|---|---|---|---|---|---|---|---|
| Example | Example | Example | Example | Example | Example | Example | Comparative |
| 11 | 12 | 13 | 14 | 15 | 16 | 17 | Example 1 |
| Method of forming light-shielding image | | | | | | | |
| Transfer | Transfer | Transfer | Transfer | Transfer | Transfer | Transfer | Transfer |
| method | method | method | method | method | method | method | method |

Reflected light-absorbing layer

| Light-absorbing substance | | C.B | C.B | C.B | C.B | C.B | C.B. | C.B. | — |
|---|---|---|---|---|---|---|---|---|---|
| Optical transmission density | | 0.60 | 0.60 | 0.60 | 0.60 | 0.60 | 0.20 | 3.20 | — |
| Film thickness (μm) | | 0.26 | 0.26 | 0.26 | 0.26 | 0.26 | 0.09 | 1.39 | — |
| Light-absorbing layer | | | | | | | | | |
| Absolute reflectance of this layer | | 7% | 6% | 22% | 21% | 5.0% | 20% | 20% | 50% |
| alone (%) | | | | | | | | | |
| Optical transmission density | | 2.0 | 3.4 | 1.0 | 1.3 | 0.8 | 1.0 | 1.0 | 0.5 |
| Shape- | Kind | Silver | Silver | Silver | Silver | Silver | Silver | Silver | Silver |
| anisotropic | | particle | particle | particle | particle | particle | particle | particle | particle |
| fine metal | Particle-diameter | 1.6 | 1.5 | 1.7 | 4.0 | 1.7 | 1.7 | 1.7 | 4.0 |
| particles | distribution | | | | | | | | |
| | D90/D10 | | | | | | | | |
| | Aspect ratio | 4.0 | 3.0 | 1.5 | 6.0 | 1.5 | 1.5 | 1.5 | 1 |
| | Particle diameter | 250 | 117 | 30 | 55 | 300 | 30 | 30 | 20 |
| | (nm) | | | | | | | | |
| | Minor axis (nm) | — | 60 | — | — | — | — | — | — |
| | Major axis (nm) | — | 180 | — | — | — | — | — | — |
| | Shape (irregular | 1:9 | Rod-shape | 9:1 | 8:2 | 1:9 | 9:1 | 9:1 | Sphere |
| | particles: tabular | | | | | | | | |
| | particles) | | | | | | | | |
| | Volumetric metal | 17.6 | 17.6 | 17.6 | 17.6 | 17.6 | 17.6 | 17.6 | 60 |
| | ratio (%) | | | | | | | | |

| | | | | | | | | |
|---|---|---|---|---|---|---|---|---|
| Color tone | Black | Black | Black | Black | Black | Black | Black | Silver |
| Film thickness (μm) | 0.24 | 0.24 | 0.24 | 0.24 | 0.24 | 0.24 | 0.24 | 0.20 |

Reflected light-absorbing layer +
Light-absorbing layer

| Entire optical transmission density | 2.6 | 4.0 | 1.6 | 1.9 | 1.4 | 1.2 | 4.2 | 0.5 |
|---|---|---|---|---|---|---|---|---|
| Entire film thickness (μm) | 0.50 | 0.50 | 0.50 | 0.50 | 0.50 | 0.33 | 1.63 | 0.20 |
| Optical transmission density per | 5.2 | 8.0 | 3.2 | 3.8 | 2.8 | 3.7 | 2.6 | 2.5 |
| unit thickness | | | | | | | | |
| (optical transmission | | | | | | | | |
| density/entire thickness) | | | | | | | | |
| Reflectance on glass face side | 0.90% | 0.90% | 0.90% | 0.90% | 0.90% | 5.00% | 0.80% | 52.0% |
| Auxiliary layer | | | | | | | | |
| Antireflection film | Absence | Absence | Absence | Absence | Absence | Absence | Absence | Absence |
| Intermediate layer | Presence | Presence | Presence | Presence | Presence | Presence | Presence | Presence |
| (oxygen-blocking film) | | | | | | | | |
| Malfunction of device | Absence | Absence | Absence | Absence | Absence | Absence | Absence | Presence |

As is apparent from the results in Tables 2 and 3, the light-shielding image-carrying substrates of Examples 1 to 17 having a two-layered structure wherein one layer had a light-shielding image containing shape-anisotropic fine metal particles showed a high light-shielding property, even though they were thin. Moreover, they had low reflectance when seen from the viewer side.

In addition, the light-shielding image-carrying substrates of Examples had low reflectance with respect to both the TFT and glass substrate sides, and thus, liquid crystal display devices having the light-shielding image-carrying substrates had high contrast and superior display characteristics.

In particular, the light-shielding image-carrying substrates (Examples 1 to 13) having an optical density per unit film thickness of 4.0 or more and a reflectance of 1% or less were excellent. Above all, the light-shielding image-carrying substrate of Example 5 was extremely good, since the reflectance thereof was 1% or less on the substrate side at a wavelength of 555 nm and the optical density thereof per unit film thickness was 11.9.

In contrast, the light-shielding image-carrying substrate of Comparative Example 1, which contained spherical silver fine particles in the light-shielding image, reflected backlight toward the TFT side at a high level and therefore generated photoleak current, when used in a liquid crystal device. Furthermore, since this light-shielding image-carrying substrate had no reflected light-absorbing layer, it also had high reflectance on the viewer side, resulting in low contrast and malfunction of the liquid crystal display device.

Further, the sample of Comparative Example 1 having an optical property of having reflectance of more than 30% with respect to light having a wavelength of 555 nm on the liquid crystal cell side was unsatisfactory as a low-reflection black matrix substrate that suppresses photoleak current, which causes TFT malfunction, and avoids interference color.

What is claimed is:

1. A light-shielding image-carrying substrate, comprising a substrate and a light-shielding image formed on at least part of at least one face of the substrate, wherein the light-shielding image comprises at least two layers, and at least one of the at least two layers is a light-absorbing layer containing shape-anisotropic fine metal particles, and at least one of the at least two layers is a reflected light-absorbing layer.

2. The light-shielding image-carrying substrate of claim 1, wherein at least one of the at least two layers is a resin layer.

3. The light-shielding image-carrying substrate of claim 1, wherein the shape-anisotropic fine metal particles have an average particle diameter of 10 to 1,000 nm.

4. The light-shielding image-carrying substrate of claim 1, wherein the aspect ratio of the shape-anisotropic fine metal particles is 1.2 to 100.

5. The light-shielding image-carrying substrate of claim 1, wherein the shape-anisotropic particles are fine metal particles having a width of number-average particle-diameter distribution (D90/D10), which is obtained by approximating the particle-diameter distribution to normal distribution, of at least 1.2 and less than 20.

6. The light-shielding image-carrying substrate of claim 1, wherein the reflectance of the light-absorbing layer at a wavelength of 555 nm is 0.5 to 30%.

7. The light-shielding image-carrying substrate of claim 1, wherein the optical transmission density of the reflected light-absorbing layer at a wavelength of 555 nm is 0.3 to 3.0.

8. The light-shielding image-carrying substrate of claim 1, wherein the optical transmission density of the light-shielding image at a wavelength of 555 nm is in the range of 4 to 20 per 1 μm of thickness.

9. The light-shielding image-carrying substrate of claim 1, wherein the reflectance at a wavelength of 555 nm, measured at the substrate side of the light-shielding image, is 0.01 to 2%.

10. The light-shielding image-carrying substrate of claim 1, wherein the total thickness of the light-shielding image is 0.2 to 0.8 μm.

11. The light-shielding image-carrying substrate of claim 1, wherein the shape-anisotropic fine metal particles are made of at least one metal selected from the group consisting of silver, nickel, cobalt, iron, copper, palladium, gold, platinum, tin, zinc, aluminum, tungsten, and titanium.

12. The light-shielding image-carrying substrate of claim 1, wherein the volumetric metal rate of the light-absorbing layer containing the shape-anisotropic fine metal particles is 5 to 30%.

13. The light-shielding image-carrying substrate of claim 1, wherein the reflected light-absorbing layer contains at least one of carbon black, and an oxide containing at least one metal element selected from the group consisting of manganese, cobalt, iron, and copper.

14. The light-shielding image-carrying substrate of claim 1, wherein the light-shielding image has at least one auxiliary layer.

15. The light-shielding image-carrying substrate of claim 1, wherein the light-shielding image is the black matrix of a display device.

16. A transfer material, comprising a temporary support and at least two layers thereon, wherein at least one of the at least two layers is a reflected light-absorbing layer and at least one layer of the at least two layers is a light-absorbing layer containing shape-anisotropic fine metal particles.

17. The transfer material of claim 16, wherein at least one of the at least two layers is a resin layer.

18. The transfer material of claim 16, wherein the light-absorbing layer contains the shape-anisotropic fine metal particles, a binder, a monomer or oligomer, and a photopolymerization initiator or initiator system.

19. The transfer material of claim 16, wherein the reflected light-absorbing layer contains a light-absorbing substance, a binder, a monomer or oligomer, and a photopolymerization initiator or initiator system.

20. The transfer material of claim 16, further comprising a thermoplastic resin layer and/or an intermediate layer in addition to the reflected light-absorbing and light-absorbing layers.

21. The transfer material of claim 16 for use in forming the black matrix of a display device.

22. The transfer material of claim 16 for use in forming a light-shielding image on a light-shielding image-carrying substrate comprising a substrate and a light-shielding image formed on at least part of at least one face of the substrate, wherein the light-shielding image comprises at least two layers, and at least one of the at least two layers is a light-absorbing layer containing shape-anisotropic fine metal particles, and at least one layer of the at least two layers is a reflected light-absorbing layer.

23. A method of forming a light-shielding image, comprising:
providing the transfer material of claim 16 and transferring the at least two layers on the temporary support onto a substrate;
patternwise exposing the at least two layers; and
developing the at least two layers patternwise exposed to remove an unexposed area.

24. A color filter prepared by using the light-shielding image-carrying substrate of claim 1.

25. A color filter prepared by using the transfer material of claim 16.

26. A display device comprising the light-shielding image-carrying substrate of claim 1 and a color filter prepared by using the light-shielding image-carrying substrate.

27. A display device comprising a color filter prepared by using the light-shielding image-carrying substrate of claim 1 and a transfer material having at least two layers on a temporary support, wherein at least one of the at least two layers is a reflected light-absorbing layer, and at least one layer of the at least two layers is a light-absorbing layer containing shape-anisotropic fine metal particles.
